(19) United States
(12) Patent Application Publication
(10) Pub. No.: US 2012/0059669 A1
(43) Pub. Date: Mar. 8, 2012

(54) ELECTRONIC HEALTH RECORD SYSTEM WITH NURSING RECORDS

(76) Inventors: Luann Whittenburg, Alexandria, VA (US); Peter S. Goltra, Middleburg, VA (US)

(21) Appl. No.: 13/031,510

(22) Filed: Feb. 21, 2011

Related U.S. Application Data
(60) Provisional application No. 61/379,709, filed on Sep. 2, 2010.

(51) Int. Cl. G06Q 50/24

(52) U.S. Cl. 705/3

(57) ABSTRACT

An electronic health records system stores medical data and nursing data. The medical data is associated with a physician's findings for an encounter with a patient. The nursing data is associated with nursing care provided to the patient. The electronic health records system generates separate or linked physician and nurse interfaces that can be used to enter and review the medical and nursing data as desired. The electronic health records system also manages nurse scheduling.

### CROSS REFERENCE TO RELATED APPLICATIONS

This application claims priority to U.S. Provisional Application No. 61/379,709, filed on Sep. 2, 2010, and entitled ELECTRONIC NURSING RECORDS, the disclosure of which is incorporated by reference herein in its entirety.

### BACKGROUND

Healthcare providers are increasingly using electronic medical records for the management of patient health data. The records typically include patient notes, where a detailed account of a physicians encounter with the patient is recorded. For example, the patient note may include a record of the patient's chief complaint, the symptoms that the patient was exhibiting, the results of a physical examination, the patient's relevant medical history, the results of any tests that were performed, the physician's diagnosis, and the therapy that was instituted.

While the physician's encounter is often well documented in an electronic medical record, electronic records have not been adequately developed to include in the same record the activities of nurses who are providing care to the patient.

### SUMMARY

In general terms, this disclosure is directed to electronic nursing records. In one possible configuration and by non-limiting example, the electronic nursing records are automatically prompted by the physician's medical findings as documented in the medical record.

One aspect is a system comprising a data store and a computing device. The data store is encoded on at least one memory device and comprises: medical terminology including medical terms; relationship data defining hierarchical relationships between the medical terms; nursing terminology including nursing terms; relationship data defining hierarchical relationships between the nursing terms, and further defining relationships between at least some of the nursing terms and at least some of the medical terms; and at least one medical record associated with a patient, the medical record including medical terms from the medical terminology that identify at least one medical finding for the patient. The computing device is in data communication with the data store, wherein the computing device is programmed to retrieve the at least one medical finding from the medical record and to automatically identify at least one nursing term from the nursing terminology associated with the medical finding.

Another aspect is a method of generating a user interface for use in providing nursing care to a patient. The method comprises automatically identifying, with a computing device, a category of nursing care based on at least one element of a patient's medical record; and generating a user interface including a nursing order associated with the category of nursing care, the nursing order defining a protocol of at least one action to be performed by at least one nurse to care for a patient.

A further aspect is a method of displaying health information associated with a patient. The method comprises generating data defining a user interface with a computing device, the user interface including a physician window and a nursing window, the physician window configured to display medical data associated with a patient, and the nursing window configured to display nursing data associated with the patient, wherein the physician window and the nursing window are synchronized such that the medical data displayed in the physician window is associated with the nursing data displayed in the nursing window.

Yet another aspect is a system comprising a data store and a computing device. The data store is encoded on at least one memory device and includes nurse schedule data. The nurse schedule data identifies procedures to be performed by nurses and an estimated time required to perform each procedure. The computing device is in data communication with the data store, and is programmed to retrieve the nurse scheduling data and to generate a report displaying a workload for one or more nurses utilizing the nurse scheduling data.

A further aspect is a method of evaluating a nurse staffing level. The method includes determining a set of procedures to be performed by one or more nurses over a period of time; computing, with a computing device, a scheduled nurse time, wherein the scheduled nurse time is an estimated duration of time required to complete the set of procedures; computing an available nurse time, wherein the available nurse time is a combined duration of time that the one or more nurses are expected to work over the period of time; and comparing the scheduled nurse time to the available nurse time.

### BRIEF DESCRIPTION OF THE DRAWINGS

FIG. 1 is a schematic block diagram illustrating an exemplary electronic healthcare system.

FIG. 2 is a schematic block diagram illustrating the generation of an example user interface providing a combined physician and nursing view of a patient's record.

FIG. 3 is a diagram illustrating a hierarchy of nursing terminology.

FIG. 4 illustrates an exemplary architecture of a computing device.

FIG. 5 is a schematic block diagram illustrating an example of medical terminology of the electronic health records system.

FIG. 6 is a schematic block diagram illustrating an example of nursing terminology of the electronic health records system.

FIG. 7 is a schematic block diagram illustrating several exemplary relationship tables identifying relationships between nursing terms of the nursing terminology.

FIG. 8 is a schematic order time chart of the nursing terminology.

FIG. 9 is a schematic block diagram of an example server computing device of the electronic health records system.

FIG. 10 is a flow chart illustrating an example method of operating the server computing device.

FIG. 11 is a flow chart illustrating an example method of operating an admission, discharge, and transfer (ADT) engine of the electronic health records system.

FIG. 12 is a screen shot of an example user interface of the ADT engine.

FIG. 13 is a schematic block diagram of an example medical records engine of the electronic health records system.

FIG. 14 is a screen shot of an example user interface generated by the medical records engine.

FIG. 15 is another screen shot of the example user interface shown in FIG. 14.

FIG. 16 is a schematic block diagram of an example nursing engine of the electronic health records system.

FIG. 17 is a screen shot of an example user interface for developing a nursing plan of care.

FIG. 18 is another screen shot of the example user interface shown in FIG. 17.

FIG. 19 is another screen shot of the example user interface shown in FIG. 17.

FIG. 20 is a screen shot of an example user interface for implementing the plan of care for a patient.

FIG. 21 is a screen shot of an example user interface including a combined view of medical and nursing data.

FIG. 22A is a first portion of an example report of nursing care generated by the electronic health record system.

FIG. 22B is a second portion of the example report shown in FIG. 22A.

FIG. 23 is an example report of nursing interventions including aggregate data.

FIG. 24 is another example report of nursing interventions including aggregate data.

FIG. 25 is a schematic block diagram illustrating operations performed by an example nurse scheduling engine that utilizes nurse scheduling data to generate a nursing schedule.

FIG. 26 is a schematic diagram of an example nurse staffing report generated by the nurse scheduling engine.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

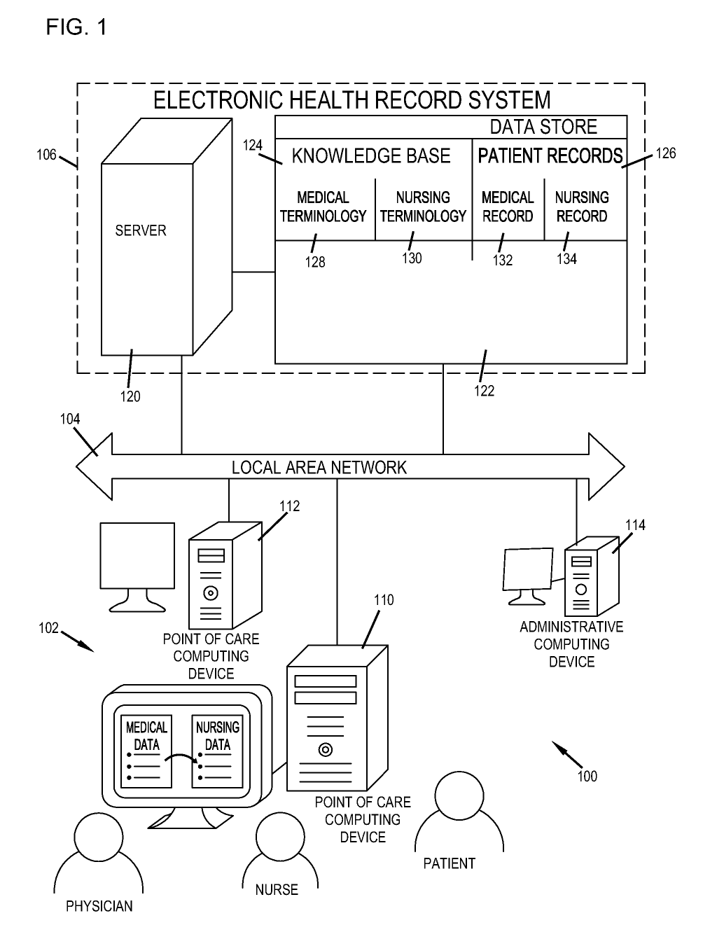

FIG. 1 is a schematic block diagram illustrating an exemplary electronic healthcare system 100. A physician and a nurse interact with the electronic healthcare system 100 to make a record of patient encounters. The electronic healthcare system 100 includes a plurality of client computing devices 102, a network 104, and an electronic health record system 106. The client computing devices include, for example, a point of care computing device 110, a point of care computing device 112, and an administrative computing device 114. The electronic health record system includes a server computing device 120 and a data store 122. The data store includes a knowledge base 124 and patient records 126. The knowledge base includes medical terminology 128 and nursing terminology 130. The patient records include a medical record 132 and a nursing record 134.

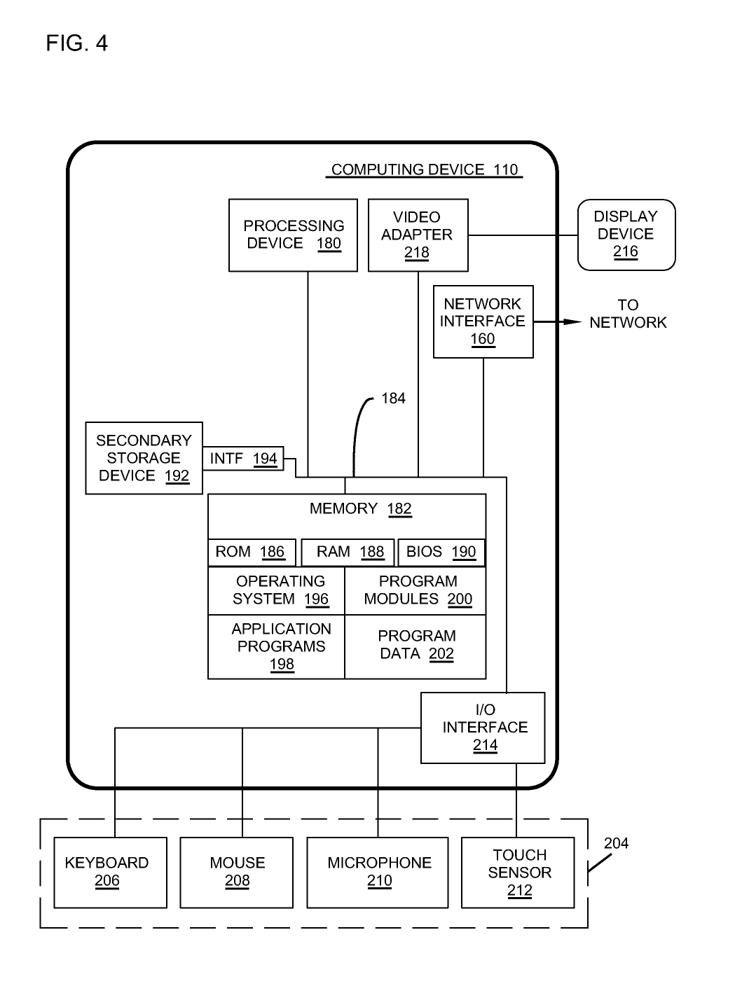

Client computing devices 102 are configured to communicate with electronic health record system 106 through a network 104. Several examples of client computing devices 102 are shown, and include point of care computing devices 110 and 112, and an administrative computing device 114. The point of care computing devices 110 and 112 are located at or near to the location where an encounter between the caregivers and the patient occurs. For example, the computing devices may be located in an examination room, a hospital room, an operating room, a hallway adjacent to one of these rooms, a nursing station, a physician's office, etc. In some embodiments, the point of care computing device 110, 112 is located on a wheeled cart, to permit the computing device to be moved around the healthcare facility. In yet other embodiments, the point of care computing device 110, 112 is a mobile device, such as a smart phone, touch sensitive display device, or other mobile device. A more detailed example of a client computing device 102 is shown in FIG. 4.

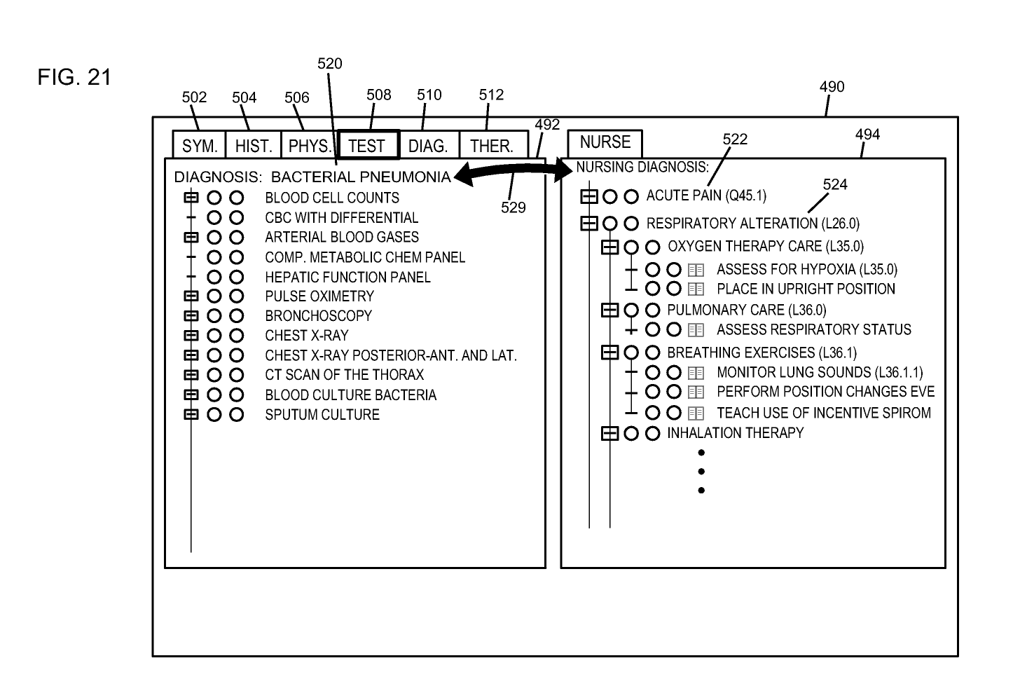

As discussed in more detail herein, the point of care computing devices 110 and 112 operate to communicate with electronic health record system, and to generate a user interface that is displayed to the caregiver on a display of the computing devices 110 and 112. The user provides inputs through an input device to the computing device 110 and 112, which are communicated to the electronic health record system 106. Data that is input can then be stored in the patient records 126 of the data store 122. One example of a user interface is shown on the display device of the computing device 110. In this example, the user interface displays a first window including medical data, and a second window including nursing data. The medical data is retrieved from the medical record 132, while the nursing data is retrieved from the nursing record 134. The arrow illustrates how the nursing data can be displayed based, at least in part, upon the medical data, as described in more detail herein. For example, FIG. 21 illustrates this combined view in which medical data and nursing data are visible simultaneously in the user interface.

Additional client computing devices 102 are included in some embodiments, such as an administrative computing device 114. A hospital administrator, or other user, can utilize computing device 114 to view reports from electronic health record system 106. Such reports can show, for example, the care that has been provided to a particular patient over a period of time, or reports showing the aggregate of care that has been provided to a group of patients over a period of time. This information can be used by the administrator to identify current staffing needs, project future staffing needs, or provide other reports, such as discussed herein, to improve the operation of the healthcare facility.

The network 104 is a data communication network that communicates digital data between computing devices. One example of the network 104 is a local area network. Other embodiments include other networks, however, such as the Internet, and enterprise network, or other data communication networks. The network 104 can also be a combination of multiple networks. The network 104 can include wired communication, wireless communication, optical communication, and combinations of communication types.

The electronic health record system 106 manages the electronic patient records 126. In this example, the electronic health record system 106 includes a server computing device 120 and a data store 122. Some embodiments include multiple server computing devices 120, and some embodiments include multiple data stores 122, such as for redundancy or for distributed processing of server tasks and communication.

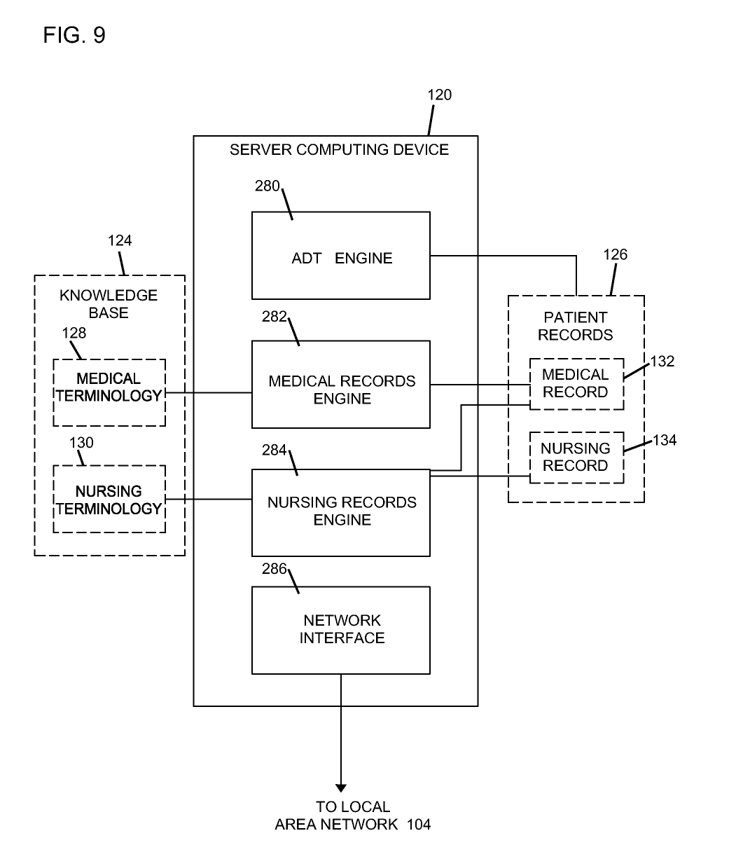

The server computing device 120 is a computing device that operates to communicate with the client computing devices 102. In one example embodiment, the server 120 performs tasks, such as managing a list of current patients within the healthcare facility, managing the patient records 126, generating a user interface that is displayed at the point of care computing devices 110 and 112 to assist the caregivers in performing their tasks associated with a patient encounter, receiving information from the caregivers through the user interface detailing the patient encounter, and storing the information about the patient encounter in the patient record 126. As discussed in more detail below, some embodiments of the server 120 include an Admission, Discharge, and Transfer (“ADT”) engine, a medical records engine, a nursing records engine, and a network interface. The medical records engine operates to generate a physician interface and to receive information from the physician. The nursing records engine operates to generate a nursing interface and to receive information from the nurse. The operation of the server 120 is illustrated in more detail with reference to FIGS. 9-24, which describe various possible embodiments of the server 120 along with other components of the electronic healthcare system 100.

In some embodiments, the server computing device 120 is a web server. In another possible embodiment, the server computing device 120 is a file server. In yet other embodiments, the server computing device is both a web server and a file server.

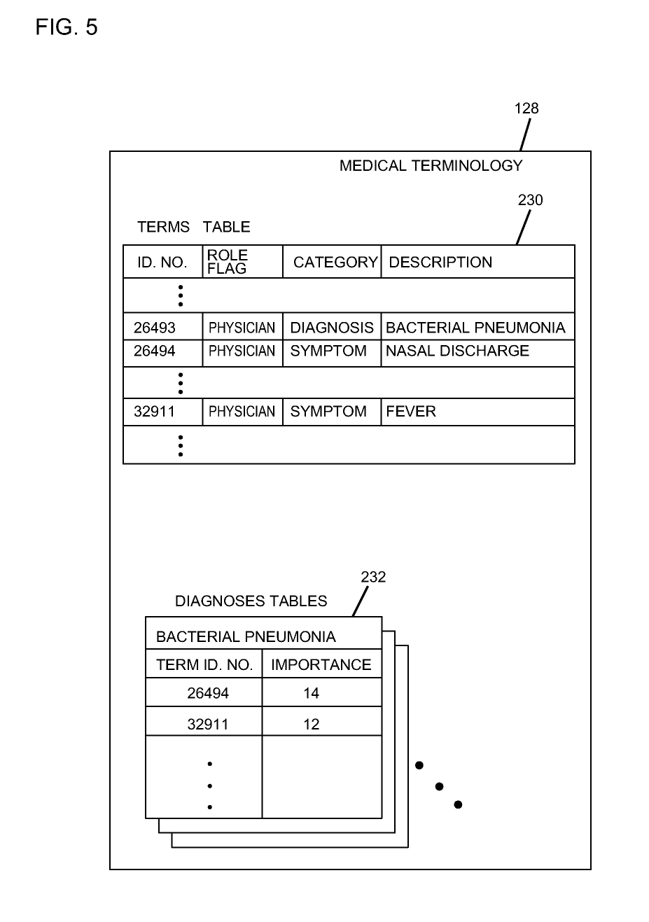

The data store 122 is a digital data storage system that stores the electronic records of the electronic health record system. In this example, the data store 122 includes a knowledge base 124 and patient records 126. The knowledge base 124 contains a set of terms that can be used to describe a patient encounter. In some embodiments, the knowledge base 124 also contains data that defines relationships between the terms. The knowledge base 124 includes both medical terminology and nursing terminology. More detailed examples of the data store 122 are provided herein with reference to FIGS. 5-8.

The medical terminology 128 includes, for example, a list of terms that can be used by a physician to describe a patient encounter in a medical record 132. The medical terminology 128 can also include relationship data that defines relationships between the medical terms. For example, a diagnosis of bacterial pneumonia can be related to typical medical findings of a cough and a fever, which are frequent symptoms of that diagnosis. In some embodiments, the medical terminology 128 is grouped according to organ group, where selected medical terms from the medical terminology 128 are associated with each organ group as appropriate.

The nursing terminology 130 includes a list of terms that can be used by a nurse to describe nursing care provided to a patient. The nursing terminology 130 can also include data defining a hierarchical relationship between the terms, and additional relationships between the terms, such as described herein. In some embodiments, nursing terminology is also grouped according to the same organ groupings as the medical terminology, where a set of associated medical terminology is associated with each organ group.

The particular client-server structure described in FIG. 1 is provided as just one of the many possible network structures. For example, in some embodiments the server 120 is a web server that communicates across a network 104, such as the Internet using standard network communication protocols, such as hypertext transfer protocol, hypertext markup language, transmission control protocol/internet protocol. In another embodiment, the client computing devices 102 are terminal devices, or thin clients. In another possible embodiment, the point of care computing device 110 and the server 120 are the same computing device, or set of computing devices. For example, the electronic health record system 106 is a software application operating on a single computing device, or single set of computing devices, in some embodiments. In further embodiments, computing device 110 is not located at a point of care.

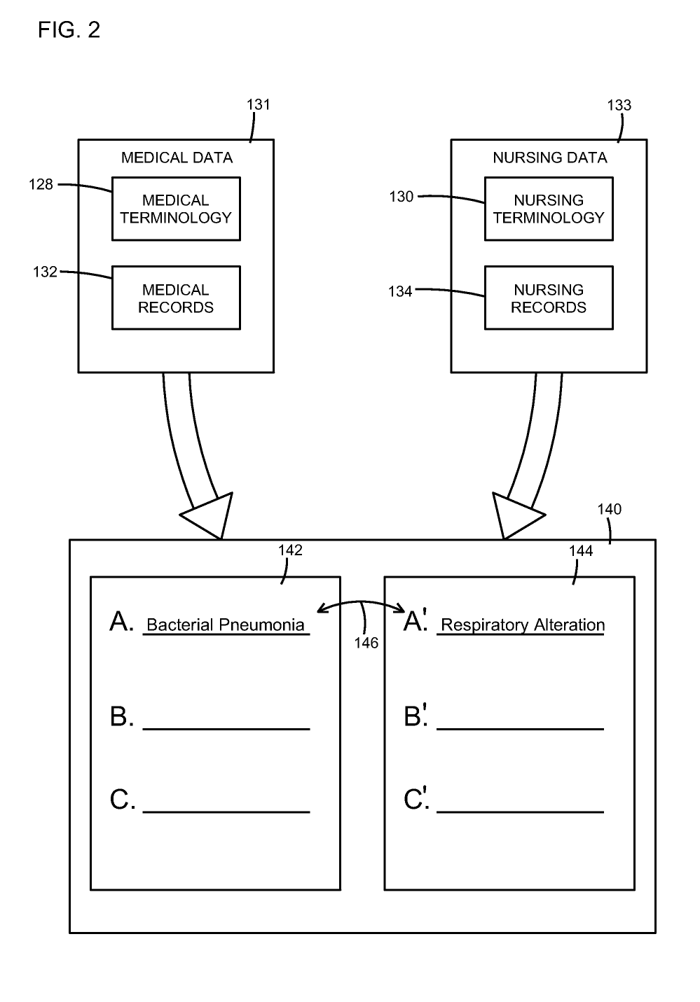

FIG. 2 is a schematic block diagram illustrating the generation of an example user interface 140, which provides a combined physician and nursing view of a patient's records. The combined view links the medical data with the nursing data in a single display that permits the physician and nurse to each see what the other is doing.

The user interface 140 is generated from the medical data 131 and nursing data 133, which are both stored in the data store 122. The medical data 131 includes both the medical terminology 128 and the medical record 132. The nursing data 133 includes both the nursing terminology 130 and the nursing record 134.

The user interface 140 includes a medical data window 142 in which selected data from the medical data 131 is displayed, and a nursing data window 144 in which selected data from the nursing data 133 is displayed. The medical data window 142 and the nursing data window 144 are displayed side-by-side to permit both to be visible simultaneously.

In some embodiments, the user interface 140 presents data in the medical data window 142 and the nursing data window 144 such that the data is synchronized. For example, when medical data relating to a particular medical finding is displayed in the medical data window 142, the nursing data relating to that medical finding is automatically displayed in the nursing data window 144, so that both are visible at the same time in the user interface 140.

Referring to FIG. 2, the medical data window 142 includes a display of three medical terms, represented as A, B, and C. Examples of medical terms are medical findings, such as a medical diagnosis. A more specific example of a medical finding is the medical diagnosis of Bacterial Pneumonia, displayed as finding A. When finding A is displayed in the medical data window 142, the nursing data window 144 is synchronized with the medical data window 142 so that nursing data associated with finding A is displayed in the nursing data window 144. More specifically, the nursing data window 144 includes nursing terms represented as A′, B′, and C′. An example of a nursing term is the nursing diagnosis of Respiratory Alteration, which is displayed as nursing term A′. Nursing term A′ is related to medical finding A, as represented by an arrow 146, and therefore they are both displayed in the user interface 140. Other nursing terms are also or alternatively displayed in other embodiments, such as nursing interventions, orders, and actions. A more detailed example of the user interface 140 is the user interface 490, which is illustrated and described herein with reference to FIG. 21.

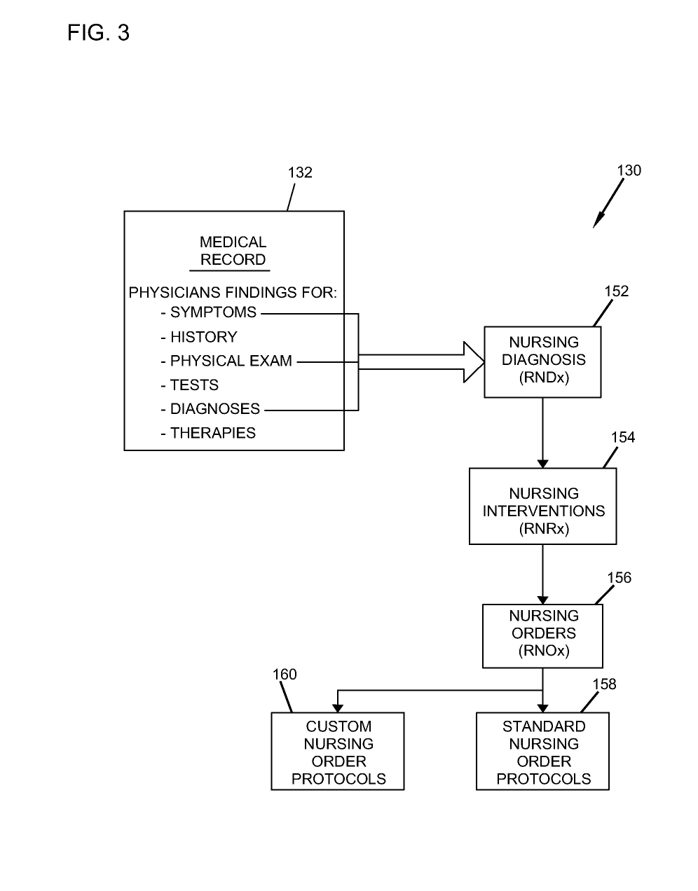

FIG. 3 is a diagram illustrating a hierarchy of the nursing terminology 130 as defined in the knowledge base 124. FIG. 3 also illustrates a method of providing nursing care. The hierarchy of the nursing terminology 130 includes nursing diagnoses (RNDx) 152, nursing interventions (RNRx) 154, nursing orders (RNOx) 156, and standard nursing order protocols 158. Some embodiments further include custom nursing order protocols 160.

The nursing terminology 130 is directly linked to the information that may be contained within the medical record 132 of a patient. The medical record 132 includes, for example, findings documented by a physician describing the physician's findings from a particular patient encounter. Such medical findings can be categorized into symptoms, history, physical examination, tests, diagnoses, and therapies.

In some embodiments, the nursing terminology 130 is directly linked to medical terminology that may be found in the patient's medical record 132, such as symptoms, history, physical examination findings, test results, medical diagnoses, or therapies. More specifically, in some embodiments, nursing diagnoses are linked to at least one of medical findings that, when found in the medical record, will likely require the type of nursing care associated with the respective nursing diagnosis.

Although various additional examples are described herein, an example may be helpful to illustrate the concept. If a patient is examined by a physician and found to have physical symptoms of a fever, chest congestion, nasal discharge, and acute pain in the chest region, the physician may conclude that the patient has bacterial pneumonia, and will record this as the medical diagnosis. Each of the findings will then be recorded in the medical record 132. Based on these findings, the relevant nursing diagnoses can be automatically identified and suggested to (or selected for) the nurse to assist the nurse in developing a plan of care for the patient. Based on the findings found in this patient's medical record 132, the nursing diagnosis of Respiratory Alteration can be automatically identified as being a likely nursing diagnosis for this patient, to be included in the plan of care.

Nursing diagnoses 152 form the top-level or root nodes of the nursing terminology 130 hierarchy. The nursing diagnoses 152 are linked to one or more nursing interventions 154. The nursing interventions 154 are linked to one or more nursing orders 156. The nursing order 156 provides a list of one or more standard nursing order protocols 158.

Each nursing diagnosis 152 is associated with at least one nursing intervention 154. The nursing interventions 154 are the overall categories of nursing care that can be provided to the patient. An example of a nursing intervention 154 is Maintain Fluid Balance, which defines an overall category of nursing care involving the maintenance of a patient's fluid balance. Another example of a nursing intervention 154 is Oxygen Therapy Care. Each nursing intervention 154 is linked to one or more nursing diagnoses 152 in which the nursing intervention 154 is likely to be required. For example, the nursing intervention 154 of Oxygen Therapy Care is linked to the nursing diagnosis 152 of Respiratory Alteration.

Each nursing intervention 154 is associated with at least one nursing order 156. The nursing orders 156 will accomplish the nursing intervention 154, sometimes using standard or custom nursing order protocols for documentation. Examples of the nursing orders 156 for the nursing intervention 154 of Oxygen Therapy Care are Assess Respiratory Status, Titrate O2 to Maintain Saturation Value, Place in Upright Position, Teach Purpose of Oxygen Therapy, and Report Oxygenation Complications.

The nursing orders 156 are also sometimes referred to herein as checklists, in some embodiments. The standard nursing order protocols 158 can include physical care therapies provided to a patient, such as respiratory suctioning, such as placing the patient in an upright position, and can also include documentation of nursing care and findings. Similar to the way that physician findings are stored in medical record 132, nursing findings can also be stored in the nursing record 134 (shown in FIG. 1) according to certain categories, such as symptoms, history, vital signs, physical examination findings, values shown on patient monitors, and the performance of and reporting of direct care.

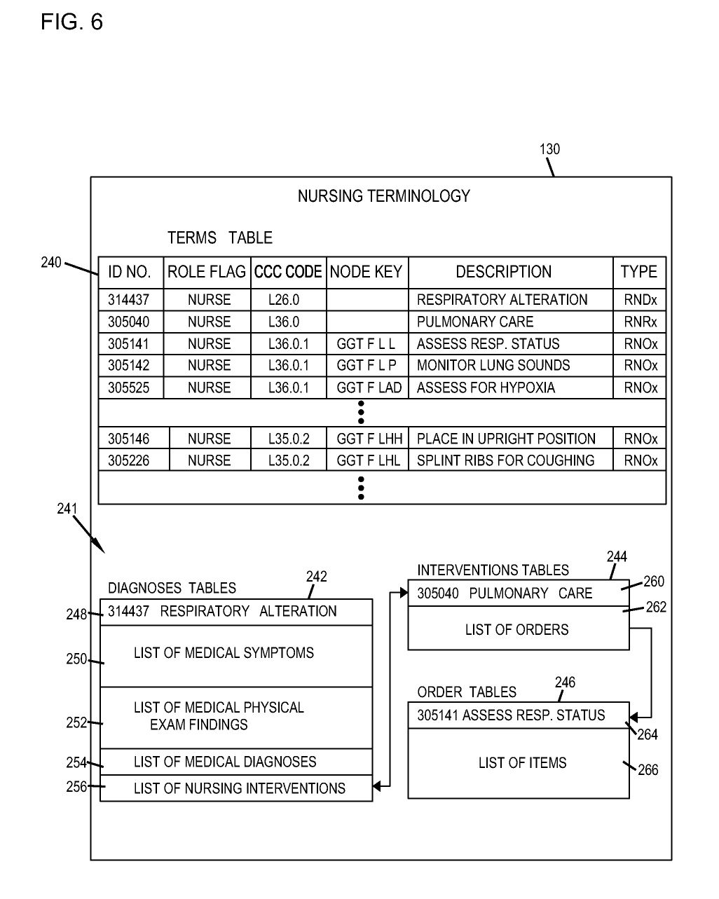

For example, a nursing order 156 of Assess Respiratory Status includes standard nursing order protocols 158 to document the respiratory status (e.g., difficulty breathing, rapid breathing, wheezing, respiration rate and rhythm, air hunger, etc.) or perform lung and respiration auscultation specifying an interval to check the respiration rate on the patient's monitor and the notification parameters for breaths per minute above and below an entered value. Nursing findings can be distinguished from medical findings in the patient records 126, if desired, such as by including a nursing flag in all nursing findings, as discussed in more detail herein (see, for example, FIG. 6).

Some embodiments include custom nursing order protocols 160 and custom actions 162 that override the standard nursing order protocols 158. Customized nursing order protocols can be used, by a hospital administrator, caregiver, or other user to define typical procedures that should be followed, which may deviate from the standard nursing orders 156 or standard nursing order protocols 158. Custom nursing order protocols 160 can be defined, for example, by a hospital administrator, through administrative computing device 114 (shown in FIG. 1). Once a custom nursing order protocol 160 has been generated, the custom nursing order protocol 160 overrides the respective standard nursing order protocol 158 so that the custom nursing order protocol 160 will be used in its place. A custom nursing order protocol 160 can include more, fewer, or different sets of list items as compared to the standard nursing order protocols 158 associated with a nursing order 156.

FIG. 4 illustrates an exemplary architecture of a computing device that can be used to implement aspects of the present disclosure, including any of the plurality of client computing devices 102 or a server computing device 120. The computing device illustrated in FIG. 4 can be used to execute the operating system, application programs, and software modules (including the software engines) described herein. By way of example, the computing device will be described below as the point of care computing device 110. To avoid undue repetition, this description of the computing device will not be separately repeated herein for each of the other computing devices, including the point of care computing device 112, the administrative computing device 114, and the server computing device 120, but such devices can also be configured as illustrated and described with reference to FIG. 4.

The computing device 110 includes, in some embodiments, at least one processing device 180, such as a central processing unit (CPU). A variety of processing devices are available from a variety of manufacturers, for example, Intel or Advanced Micro Devices. In this example, the computing device 110 also includes a system memory 182, and a system bus 184 that couples various system components including the system memory 182 to the processing device 180. The system bus 184 is one of any number of types of bus structures including a memory bus, or memory controller; a peripheral bus; and a local bus using any of a variety of bus architectures.

Examples of computing devices suitable for the computing device 110 include a desktop computer, a laptop computer, a tablet computer, a mobile device (such as a smart phone, an iPod® or iPad® mobile digital device, or other mobile devices), or other devices configured to process digital instructions.

The system memory 182 includes read only memory 186 and random access memory 188. A basic input/output system 190 containing the basic routines that act to transfer information within computing device 110, such as during start up, is typically stored in the read only memory 186.

The computing device 110 also includes a secondary storage device 192 in some embodiments, such as a hard disk drive, for storing digital data. The secondary storage device 192 is connected to the system bus 184 by a secondary storage interface 194. The secondary storage devices 192 and their associated computer readable media provide nonvolatile storage of computer readable instructions (including application programs and program modules), data structures, and other data for the computing device 110.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 192 or memory 182, including an operating system 196, one or more application programs 198, other program modules 200 (such as the software engines described herein), and program data 202. The computing device 110 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a caregiver, such as the physician or the nurse, provides inputs to the computing device 110 through one or more input devices 204. Examples of input devices 204 include a keyboard 206, mouse 208, microphone 210, and touch sensor 212 (such as a touchpad or touch sensitive display). Other embodiments include other input devices 204. The input devices are often connected to the processing device 180 through an input/output interface 214 that is coupled to the system bus 184. These input devices 204 can be connected by any number of input/output interfaces, such as a parallel port, serial port, game port, or a universal serial bus. Wireless communication between input devices and the interface 214 is possible as well, and includes infrared, BLUETOOTH® wireless technology, 802.11a/b/g/n, cellular, or other radio frequency communication systems in some possible embodiments.

In this example embodiment, a display device 216, such as a monitor, liquid crystal display device, projector, or touch screen display device, is also connected to the system bus 184 via an interface, such as a video adapter 218. In addition to the display device 216, the computing device 110 can include various other peripheral devices (not shown), such as speakers or a printer.

When used in a local area networking environment or a wide area networking environment (such as the Internet), the computing device 110 is typically connected to the network through a network interface, such as an Ethernet interface 220. Other possible embodiments use other communication devices. For example, some embodiments of the computing device 110 include a modem for communicating across the network.

The computing device 110 typically includes at least some form of computer-readable media. Computer readable media includes any available media that can be accessed by the computing device 110. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 110.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

FIG. 5 is a schematic block diagram illustrating an example of the medical terminology 128 that can be stored in data store 122 of the electronic health records system 106 (shown in FIG. 1). In this example, the medical terminology 128 includes a terms table 230 and a diagnoses tables 232.

The medical terminology 128 is provided to define standardized medical terminology that can be used to document a patient encounter in a patient's medical record 132 (shown in FIG. 1). The terminology can be organized with data structures, such as tables (or other data structures). In this example, medical terminology is organized by a terms table 230 and diagnoses tables 232. An example of the medical terminology 128 is the MEDCIN® knowledge engine, distributed by Medicomp Systems, Inc, of Chantilly, Va.

Terms table 230 stores a list of medical terms. In some embodiments, terms table 230 contains more than 250,000 medical terms. In some embodiments, the terms define a standardized medical terminology, that can be used to generate medical records 132, and for other purposes, such as coding and billing. In the example shown in FIG. 5, terms table 230 includes a separate line for each medical term.

Columns are used to associate data to the term, such as an identification number, a role flag (physician or nurse), a category, and a description. The identification number is a unique number that is used to identify the term. The role flag is used to identify each term in the terms table 230 as being associated with a physician role. Some embodiments do not include a role flag, but the role flag can be useful to distinguish medical terms from nursing terms, such as if the terms are stored in a common data structure. Each term is associated with a category, in some embodiments. Examples of categories include symptoms, history, physical examination findings, tests (including test results), diagnoses, and therapy. The description provides the text form of the term.

Several examples are shown in the example table 230 shown in FIG. 5. The first term is Bacterial Pneumonia, as noted in the description field of the first line. This term has a unique identification number of 26439, a role flag of Physician, and a category of Diagnosis. The category of Diagnosis indicates that the term is a medical diagnosis. The second term in the example table 230 is for Nasal Discharge, which has an identification number of 26494, a role flag of Physician, and a category of Symptom. The category indicates that Nasal Discharge is a symptom. The third term in the example table 230 is for Fever, which has an identification number of 32911, role flag of Physician, and a category of Symptom. The category indicates that Fever is also a symptom. Table 230 will typically include many more terms.

Diagnoses tables 232 store data identifying relationships between medical terms in terms table 230. In an example embodiment, diagnoses tables 232 include a table for each medical term in terms table 230 that has a category of Diagnosis. For example, one of the diagnoses tables 232 is for the term Bacterial Pneumonia (ID No. 26439), which has the category of Diagnosis. The diagnoses table 232 includes a list of terms that are related to the diagnosis of Bacterial Pneumonia. In this example, diagnoses table 232 identifies medical terms by their respective identification numbers, including 26494 for Nasal Discharge, and 32911 for Fever. The diagnoses table 232 further includes an importance value for each medical term, which indicates the importance of the term to the diagnosis. In some embodiments the importance value is an integer from 1 to 20, where 1 represents that the term is not very important to the diagnosis and 20 indicates that the term is very important to the diagnosis. The importance value can be used by the electronic health record system 106 to filter terms, such as to display a set of terms that have the most relevance. In some embodiments the amount of filtering performed is selectable by a user, such as using the list size feature discussed herein.

FIG. 6 is a schematic block diagram illustrating an example of the nursing terminology 130 that can be stored in the data store 122 of the electronic health records system 106 (shown in FIG. 1). In this example, nursing terminology 130 includes terms table 240 and relationship tables 241. Examples of relationship tables 241 include diagnoses tables 242, interventions tables 244, and order tables 246.

The terms table 240 stores a list of nursing terms. The nursing terms can be used to document nursing care and nursing findings, such as in the nursing record 134 of a patient's record 126, as shown in FIG. 1. In some embodiments, the terms table 240 contains a different set of terms than in the medical terms table 230, shown in FIG. 5. In some embodiments, all of the nursing terms 240 are selected so that they are different than the terms in the medical terms table 230. This permits the nursing terms to be easily distinguished from the medical terms, for example.

In addition, in some embodiments each of the nursing terms are flagged as being associated with a nursing role. In some embodiments, medical terms and nursing terms are stored in a common terms table, but can be distinguished from each other by the role flag, where medical terms are associated with a physician role, and nursing terms are associated with a nurse role.

The terms table 240 typically includes at least an identification number and a description. The identification number is a unique number that is used by a computing device to identify the nursing term. The description provides a text form of the nursing term.

The terms table 240 further include additional information in some embodiments, such as a role flag, clinical care classification code, node key identifier, and type identifier. As discussed above, the role flag is provided to identify nursing terms as being associated with a nurse role. The clinical care classification code identifies a code associated with the term. Examples of clinical care classification codes are described in Clinical Care Classification (CCC) System Manual—A Guide to Nursing Documentation, version 2.0, copyright 2004 by Virginia K. Saba, EdD, RN, FAAN, FACMI, and published by Springer Publishing Co., 2007. Each nursing term in terms table 240 is associated with a CCC code to permit categorization of the terms.

In some embodiments, the CCC code is composed of five digits. The first digit is an alphabetic character code (A to U) that represents a Care Component. Examples of Care Components are shown in Table 1.

TABLE 1

| Code | Care Component |
|---|---|
| A | Activity |
| B | Bowel/gastric |
| C | Cardiac |
| D | Cognitive |
| E | Coping |
| F | Fluid volume |
| G | Health behavior |
| H | Medication |
| I | Metabolic |
| J | Nutritional |
| K | Physical regulation |
| L | Respiratory |
| M | Role relationship |
| N | Safety |
| O | Self-care |
| P | Self-concept |
| Q | Sensory |
| R | Skin integrity |
| S | Tissue perfusion |
| T | Urinary element |
| U | Life cycle |

The second and third digits of the CCC code include a two-digit code for a Core Concept (major category). Several examples of the core concepts are as follows. The Activity Component (A) includes Core Concepts of Activity Alteration (01) and Musculoskeletal Alteration (02). The Bowel/Gastric Component (B) includes Core Concepts of Bowel Elimination Alteration (03), Gastrointestinal Alteration (04), and Nausea (51). The Cardiac Component (C) includes Core Concepts of Cardiac Alteration (05) and Cardiovascular Alteration (06).

The fourth position includes a one-digit code for a subcategory of the Core Concept. A decimal point is also inserted to separate the third and fourth digits, in some embodiments. Examples of the subcategories are as follows. The Core Concept of Activity Alteration (01) includes sub-categories of Activity Intolerance (.1), Activity Intolerance Risk (.2), Diversional Activity Deficit (.3), Fatigue (.4), Physical Mobility Impairment (.5), Sleep Pattern Disturbance (.6), and Sleep Deprivation (.7). If a Core Concept does not have a sub-category, or to identify the Core Concept itself, a zero (.0) is used.

The fifth position includes a one digit code. A decimal point is inserted between the fourth and fifth digits, in some embodiments. The code can represent either an expected or actual outcome, or a nursing activity type. Examples of expected or actual outcomes include: improve (.1), stabilize (.2), or support (.3). Examples of nursing activity types include Assess (.1), Perform (.2), Monitor (.3), and Teach (.4).

For example, the term for Respiratory Alteration has a CCC code of L26.0. The Care Component of L represents the Respiration Component. The code 26 represents the Core Concept of Respiration Alteration.

The term Assess Respiratory Status has the CCC code of L36.0.1. The additional digit of .1 at the end is the activity code for Assess.

Some embodiments further include a node key. The node key defines a hierarchical tree structure for at least some of the terms in terms table 240, to identify relationships between the terms. For example, in some embodiments the tree structure associates terms with associated organ systems.

The type field identifies a type for each term. In some embodiments, types are selected from Nursing Diagnoses (RNDx), Nursing Interventions (RNRx), and Nursing Orders (RNOx).

In some embodiments, the nursing terminology 130 further includes a plurality of relationship tables 241, including diagnoses tables 242, interventions tables 244, and order tables 246. The relationship tables define the relationships between nursing terms identified in the terms table 240.

A diagnosis table 242 is provided for each nursing diagnosis (RNDx) in the nursing terms table 240, which identifies other nursing terms that are associated with the respective nursing diagnosis. In some embodiments, diagnosis tables 242 include one or more of a diagnosis identifier 248, a list of medical symptoms 250, a list of medical physical exam findings 252, a list of medical diagnoses 254, and a list of nursing interventions 256. Other medical findings can also be included in some embodiments, such as test results, history, therapies, etc.

The diagnosis identifier 248 identifies one of the nursing diagnoses that the diagnosis table 242 relates to. For example, if the diagnosis table 242 relates to the Respiratory Alteration diagnosis, the diagnosis identifier 248 is the identification number 314437 in some embodiments. Other embodiments use other identifiers, such as the diagnosis description, or combinations of identifiers. Links (e.g., a reference utilized in a linked list, a hypertext link, an XML link, or other types of links), pointers, or other types of references are used in yet further embodiments to identify a diagnosis listed in terms table 240.

The list of medical symptoms 250 identifies medical symptoms from medical terms table 230 that are related to the diagnosis. The list of medical symptoms 250 identifies those medical symptoms, for example, that would be likely to require nursing care associated with the given nursing diagnosis.

The list of medical physical exam findings 252 identifies medical physical examination findings from medical terms table 230 that are related to the diagnosis. For example, it identifies those physical examination findings that would be likely to require nursing care associated with the given nursing diagnosis.

The list of medical diagnoses 254 identifies medical diagnoses from medical terms table 230 that are related to the diagnosis. For example, it identifies those physical examination findings that would be likely to require nursing care associated with the given nursing diagnosis.

Each of these lists (the medical symptoms 250, physical examination findings 252, and diagnoses 254) are used by the electronic health record system 106 to automatically identify, or suggest, relevant nursing diagnoses based directly upon the medical data stored in the patient's medical record 132 (shown in FIG. 1). Various advantages are provided by the automatic identification of nursing diagnoses based on the medical data in the medical record 132.

For example, in some embodiments the electronic health records system 106 intelligently prompts a nurse or other user with the most likely nursing diagnoses directly from the medical data stored in the medical record 132, which allows the nurse to quickly locate and identify the one or more desired nursing diagnoses to be utilized in the nursing plan of care for a patient.

In some embodiments, the electronic health records system improves the quality of care by providing a limited list of the most likely nursing diagnoses for the patient based on the patient's current condition, rather than requiring the nurse to remember all available nursing diagnoses and independently determine in the nurses mind the best nursing diagnosis of the many possible alternatives.

Further, in some embodiments the electronic health records system requires a nurse to select one or more of the nursing diagnoses that are identified by the electronic health records system 106, to provide a level of control over the patient care provided by the nurse, based on the data in the patient's medical record.

In some embodiments, the electronic health records system 106 provides a process to override the requirement, such as by obtaining authorization from a physician or supervisor, or by requiring the nurse to enter a reason for overriding the requirement. The override operation is then logged in the nursing record 134. In some embodiments another user of the electronic health records system 106, such as a physician or hospital administrator is notified by the electronic health records system 106 when an override operation occurs.

A list of the nursing interventions 256 is also included in the diagnoses tables 242, which identifies one or more nursing interventions associated with the diagnosis.

The nursing interventions are nursing terms from the terms table 240 that include the Intervention (“RNRx”) type. The list of nursing interventions 256 defines a portion of a nursing terms hierarchy, namely the set of one or more interventions that are children of the diagnosis.

The nursing terminology 130 also includes, in some embodiments, interventions tables 244. An intervention table 244 is provided for each nursing intervention in the nursing terms table 240, which identifies other nursing terms that are associated with the respective nursing intervention. A nursing intervention is, for example, a category of nursing care that can be provided to a patient. In some embodiments, the interventions tables 244 include an intervention identifier 260 and a list of nursing orders 262. Links or other references are used in some embodiments to relate the diagnosis tables 242 with nursing intervention tables 244.

The intervention identifier 260 identifies one of the nursing interventions that the interventions table 244 relates to. For example, if the interventions table 244 relates to the Pulmonary Care intervention, the intervention identifier 260 is the identification number 305040, or the intervention description (“Pulmonary Care”), or another identifier or combination of identifiers (such as including the identification number and the intervention description). A link or another type of reference is used in some embodiments to relate the intervention table 244 to the intervention term in terms table 240.

The list of orders 262 identifies nursing orders identifies one or more nursing orders associated with the nursing intervention. The nursing orders are nursing terms from terms table 240 that include the Orders (“RNOx”) type. The list of nursing orders 262 defines a portion of the nursing terms hierarchy, namely the set of one or more orders that are children of the nursing intervention.

Nursing terminology 130 also includes, in some embodiments, orders tables 246. An orders table 246 is provided for each nursing order in the nursing terms table 240, which identifies a standard nursing order protocol. In some embodiments, orders tables 246 include an order identifier 264 and a list of items 266. Links or other references are used in some embodiments to relate the orders tables 246 with nursing orders.

The orders identifier 264 identifies the nursing orders that the orders table 246 relates to. A link or another type of reference is used in some embodiments to relate the orders table 264 to the orders term in terms table 240.

The list of items 266 identifies the elements used to document the performance of the nursing order. The list of items 266 in a standard nursing order protocol defines a set of clinical findings that are children of the nursing order.

In some embodiments, the nursing order tables 246 are defined by an electronic health records system provider, or by a third party add-on provider, to define standard nursing protocols for use by a wide variety of healthcare facilities. However, a healthcare facility may want to modify these protocols from time to time. The system permits the healthcare facility to modify the protocols by providing the capability of defining custom nursing order protocols. A custom nursing order protocol can be defined by a user associated with the healthcare facility, such as a hospital administrator, a physician, a nurse, or other authorized user, to include a different list of items 266 than the standard nursing order protocol's list of items.

A custom nursing order protocol is stored in the nursing terminology 130 in a similar manner to the standard nursing order protocols. A custom nursing order protocol table, similar to the order table 246, is stored that identifies the order to be customized. The custom order table also includes a customized list of items, which is different than the standard list of items. For example, the custom list of items can include more, fewer, or one or more different actions than in the list of items 266 of the standard nursing order protocol. When the order is selected within the electronic health records system 106, the system automatically checks to see whether a custom nursing order protocol has been generated for that order, and if so, the custom nursing order protocol is automatically utilized to override the standard nursing order protocol.

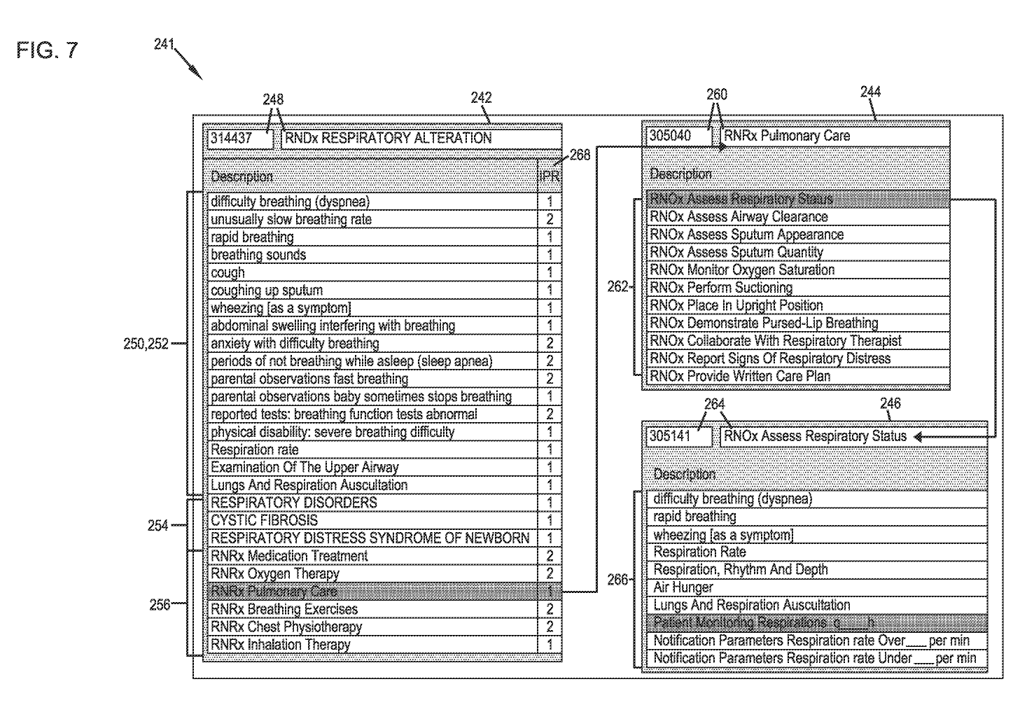

FIG. 7 is a schematic block diagram illustrating several exemplary relationship tables 241 identifying relationships between nursing terms of the nursing terminology 130. In this example, three relationship tables 241 are illustrated, including a nursing diagnosis table 242 for Respiratory Alteration, a nursing intervention table 244 for Pulmonary Care, and an order protocol table 246 for Assess Respiratory Status.

The example diagnosis table 242 includes diagnosis identifier 248, which includes the identification number for the diagnosis (314437), as well as the diagnosis description (Respiratory Alteration).

The example diagnosis table 242 includes a list of medical symptoms 250 and physical examination findings 252 that are related to the nursing diagnosis, such as Difficulty Breathing, Unusually Slow Breathing Rate, Rapid Breathing, Cough, Coughing Up Sputum, Wheezing, Abdominal Swelling, Examination of the Upper Airway, etc. The lists also include an importance rating 268 that indicates the relative importance of the medical finding to the diagnosis. In this example, the importance rating is in a range from 1 to 3, where 1 is very important, 2 is moderately important, and 3 is less important. The importance rating can be used by the electronic health records system for filtering and prioritizing, for example, such as discussed in more detail herein. The inclusion of a medical finding in the list of medical findings 250, 252 indicates that a patient who has the medical finding recorded in that patient's medical record 132 is likely to benefit from nursing care associated with the Respiratory Alteration nursing diagnosis.

The example diagnosis table 242 includes a list of medical diagnoses 254 that are related to the nursing diagnosis, such as Respiratory Disorders, Cystic Fibrosis, and Respiratory Distress Syndrome of Newborn. The inclusion of a medical diagnosis in the list of medical diagnoses 254 indicates that a patient who has been diagnosed the medical diagnosis is likely to benefit from nursing care associated with the Respiratory Alteration nursing diagnosis. In some embodiments the list of medical diagnoses 254 are associated with an importance rating that indicates the relative importance of the medical diagnosis to the nursing diagnosis.

The example diagnosis table 242 also includes a list of nursing interventions 256 that are related to the nursing diagnosis, such as Medication Treatment, Oxygen Therapy Care, Pulmonary Care, Breathing Exercises, etc. The list of nursing interventions 256 relates the diagnosis to a set of one or more nursing interventions that are related to the diagnosis. In some embodiments, links or another type of reference is used to relate the diagnosis table 242 to the one or more interventions tables 244 associated with the nursing diagnosis.

The example intervention table 244 includes intervention identifier 260, which includes the identification number for the intervention (305040), as well as the intervention description (Pulmonary Care).

The intervention table 244 further includes a list of nursing orders 262 that are related to the nursing intervention, such as Respiratory Status, Assess Airway Clearance, Assess Sputum Appearance, Assess Sputum Quantity, Assess Sputum Saturation, Perform Suctioning, etc. The list of nursing orders 262 relates the nursing intervention to a set of one or more nursing orders that are related to the intervention. In some embodiments, links or another type of reference is used to relate the intervention table 244 to the order table 246 associated with the intervention.

The example order table 246 includes order identifier 264, which includes the identification number for the order (305141), as well as the order description (Assess Respiratory Status).

The order table 246 further includes a list of items 266 that are to be performed by a nurse to complete the order, such as including assessments of the following: Difficulty Breathing, Rapid Breathing, Wheezing, Respiration Rate, Respiration Rhythm and Depth, Air Hunger, Lungs and Respiration Auscultation, Monitor Patient Respiration Frequency, etc. This example order further includes actions to establish notification parameters (such as for a breathing monitor device) to provide a notification if breathing exceeds a particular frequency or falls below a particular frequency.

The electronic health records system 106 can utilize relationship tables 241 to provide various features and functionality. For example, after medical data has been entered into the patient's medical record 132, the medical data is used by the electronic health records system 106 to automatically identify nursing diagnoses. The system retrieves medical findings from the patient's medical data, which may include symptoms, physical examination findings, test results, medical diagnoses, or other medical data, and then performs a search across the nursing diagnoses tables 240 to identify all of the nursing diagnoses tables 242 that include one or more of the medical findings. If the resulting set of diagnoses is too large, the set can be reduced to only the most important diagnoses, or to remove those diagnoses that are least important, based on the importance rating 268. The size of the resulting set of diagnoses that is displayed can be adjusted by the user in some embodiments.

The user can then review the set of diagnoses that is displayed and select the one or more diagnoses to be included in the patient's plan of care. Alternatively, the diagnoses can be automatically selected by the electronic health records system 106, such as by utilizing the importance rating 268.

Upon selection of a diagnosis, a set of relevant nursing interventions is displayed based on the list of nursing interventions 256. If desired, the set can be reduced to a subset of nursing interventions by utilizing the importance rating 268. The nursing interventions are then displayed to the user, and the user provides an input to select the one or more interventions to be included in the patient's plan of care. Alternatively, the interventions can be automatically selected by the electronic health records system 106, such as by utilizing the importance rating 268.

Upon selection of an intervention, a set of relevant nursing orders is identified by retrieving the list of nursing orders 262 from the intervention table 244 associated with the selected intervention. The nursing orders are displayed to the user, and the user is prompted to provide an input to select the one or more orders to be included in the patient's plan of care. Alternatively, the orders are automatically selected by the electronic health records system 106, such as by utilizing an importance rating stored in the intervention table 244 (similar to importance rating 268).

Once the order has been selected, the set of actions associated with the selected order can be displayed, if desired. To do so, the list of items 266 is retrieved from the order table 246 for the selected order. The actions identify the tasks that the nurse will need to complete in order to fulfill the selected order.

Once the plan of care has been established, it is utilized by the nurses to determine what needs to be done for the patient, identify what has already been done, keep a record of actions that have been completed, and document the results of actions. The plan of care and all documentation associated with the plan of care are stored by the electronic health records system 106 in the nursing record 134, shown in FIG. 1.

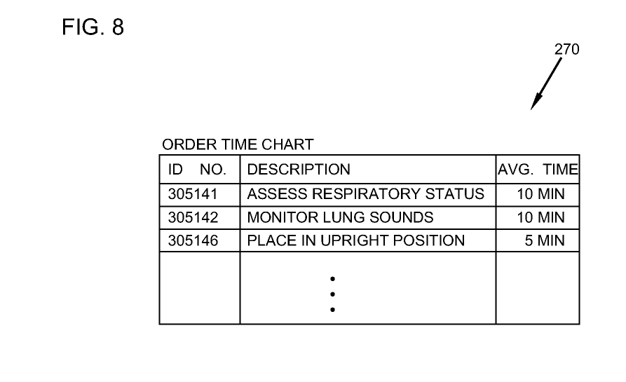

FIG. 8 illustrates an example nursing order time chart 270. In some embodiments, the electronic health record system 106 utilizes time data with respect to nursing care. Some of these features are implemented through the use of nursing order time charts 270. The nursing order time charts 270 include a list of nursing orders (such as by identification number, description, or both), and identify an average amount of time that is required by a nurse to complete the nursing order. For example, nursing order time chart 270 includes a first row that identifies an order having the identification number 305141 and description of Assess Respiratory Status. The nursing order time chart 270 also indicates that a nurse will require an average time of 10 minutes to complete this nursing order. The second row identifies an order number 305142 of Monitor Lung Sounds, and indicates that a nurse will require an average time of 10 minutes to complete this nursing order. The third row identifies an order number 305146 of Place in Upright Position, and indicates that a nurse will require an average time of 5 minutes to complete this nursing order.

This time data can be stored in a variety of alternative manners in other embodiments. For example, in another possible embodiment the terms table 240 (shown in FIG. 6) includes a column for average time. In another embodiment, interventions tables 244 or order tables 246 (also shown in FIG. 6) include average time data.

Further, average time data can alternatively or additionally be assigned to actions. The average time to complete an order can then be determined by summing the individual times of each of the actions included in an order.

The average time information can be used by electronic health record system for a variety of purposes. For example, once a plan of care has been established for a patient, the electronic health records system can perform a workload analysis, such as to determine the approximate amount of time that will be required by the nursing staff to provide the care to the patient. This information can be combined with the information for other patients, such as all of the patients in a particular unit of a healthcare facility, to generate an estimate of how many nurses will be needed to provide care to all of the patients. The time information can be used by the electronic health records system 106 to generate nurse schedules, such as to project nursing needs at particular dates or times and to determine whether the unit is likely to be overstaffed or understaffed on those dates or times. The time information can be used by the electronic health records system 106 to determine units in a healthcare facility that are improperly staffed (whether overstaffed or understaffed) and to make real-time adjustments in staffing, such as to request that one or more nurses move from areas with less need to areas of greater need. Alternatively, the location of patients can be adjusted. For example, a patient that is likely to require a large amount of nursing care can be moved or assigned to a unit that has more resources.

Time information can also be used to evaluate the costs of nursing care. A monetary value can be assigned to nursing care by multiplying the time required to provide care by a value of the care per unit of time. The value of the care per unit of time can be computed based on average or actual salaries of nurses plus the various overhead expenses. In this way the actual cost of providing care to a patient can be determined by the electronic health records system 106.

This cost information can be used by the electronic health records system for various purposes, and can also be used by people, such as an administrator for various purposes. As one example, cost information can be used to compare the cost of having a nurse perform a given task with the cost of hiring another person to perform the task. To illustrate this further, an administrator can consider the cost of having a nurse teach a patient about healthy eating habits, and can compare this with the amount a specialist would charge to provide the training. The data can be used in various ways to perform cost benefit analysis.

Although healthcare facilities typically do not charge directly for nursing care, the nursing time and cost information discussed herein provides the information that would be necessary to do so. Accordingly, some embodiments of the electronic health records system 106 maintain nursing time, cost, and fee data and provide for direct billing of nursing care. This permits the healthcare facility to charge a patient, or insurance company, for the actual care required by the patient, rather than including the cost of nursing care in the general room rates.

In some embodiments, electronic health records system 106 maintains records of the actual amount of time consumed in the performance of nursing orders. This information is then be used by electronic health records system 106 for various purposes, such as to compare the actual time consumption records with the stored average time values. The average time values can then be adjusted to more accurately reflect the average time required by nurses to perform the order at the particular healthcare facility.

Further, in some embodiments time values in nursing order time chart 270 can be customized by the healthcare facility.

FIG. 9 is a schematic block diagram of an example server computing device 120 of the electronic health records system 106. The example server computing device 120 includes an admission, discharge, transfer (ADT) engine 280, a medical records engine 282, a nursing records engine 284, and a network interface 286. The server 120 interacts with the data store 122 (shown in FIG. 1), which includes the knowledge base 124 and the patient records 126. The knowledge base 124 includes the medical terminology 128 and the nursing terminology 130. The patient records 126 include medical record 132 and nursing record 134 for each patient. In some embodiments, server 120 includes more than one computing device, such as at least two computing devices.

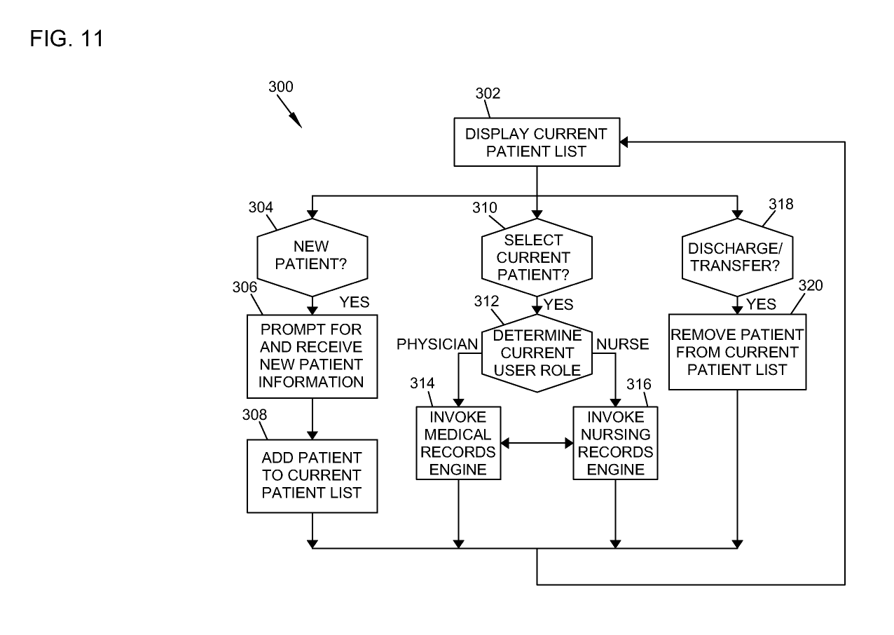

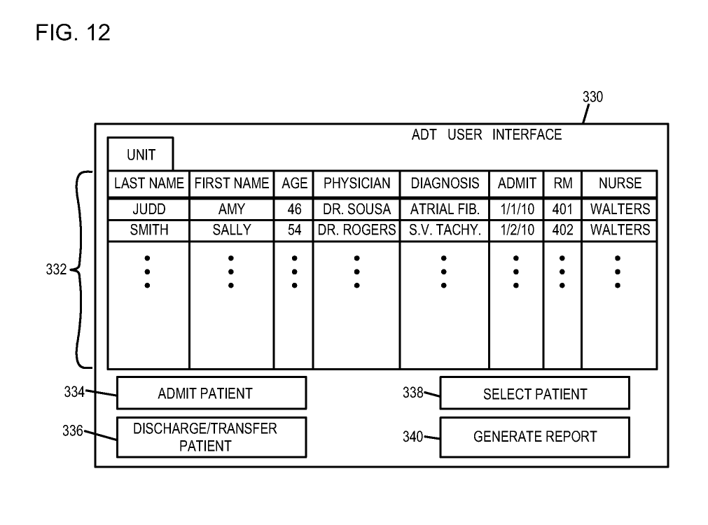

The ADT engine 280 performs patient management operations of the electronic health record system 106. The ADT engine 280 controls the entire patient care workflow, from the initial registration of a new patient during the admission process, to a transfer of the patient among different units or locations of a healthcare facility, to the eventual discharge of the patient. Examples of the ADT engine 280 are described in more detail with reference to FIGS. 11-12.

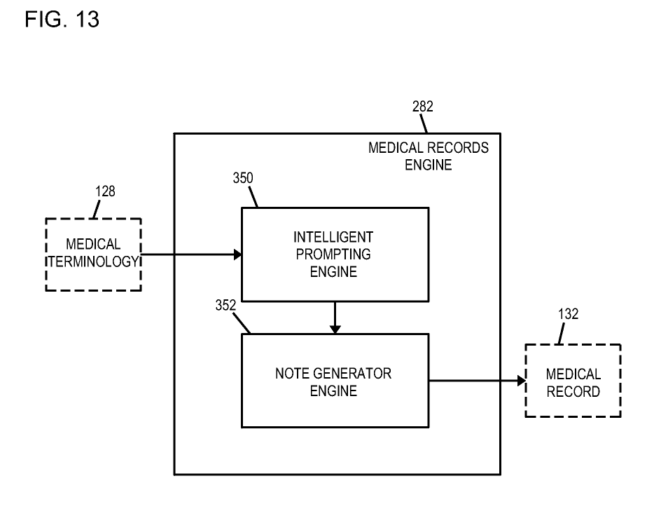

The medical records engine 282 performs operations for interfacing with a physician and managing the medical record 132. For example, the medical records engine 282 intelligently prompts the physician to assist the physician in decision making and also to assist the physician in efficiently generating a patient note to record details of a patient encounter. The medical records engine 282 utilizes data from medical terminology 128 of knowledge base 124. Examples of the medical records engine 282 are described in more detail with reference to FIGS. 13-15.

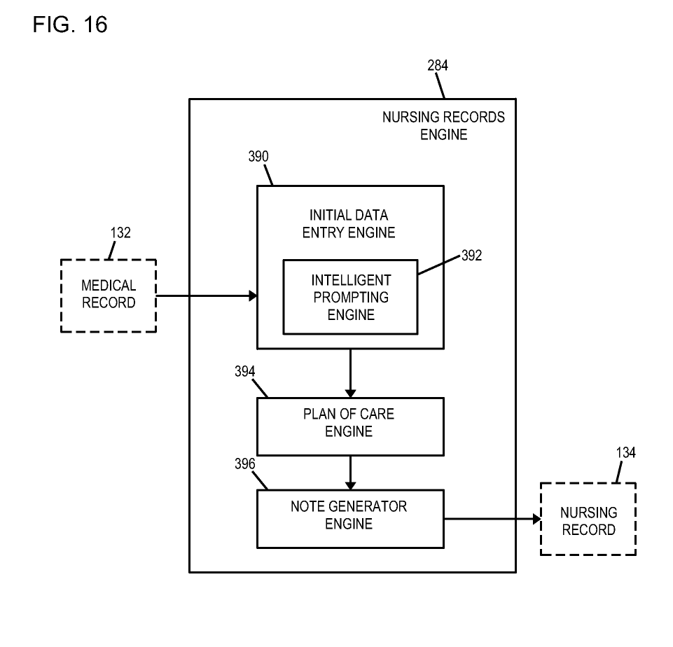

The nursing records engine 284 performs operations for interfacing with a nurse and managing the nursing record 134. For example, nursing records engine 284 guides the nurse through the initial data entry process to generate a plan of care for the patient. The initial data entry process includes an intelligent prompting engine that retrieves data from the patient's medical record 132, to automatically identify and suggest relevant nursing diagnoses to the nurse. The nursing records engine 284 also utilizes data from nursing terminology 130 of knowledge base 124. After the plan of care has been generated, the nursing records engine 284 guides the nurses through the execution of the plan of care and documentation of the actions that are performed consistent with the plan of care. The nursing records engine 284 then updates the nursing record 134 to include data documenting the care that has been provided. Examples of the nursing records engine 284 are described in more detail with reference to FIGS. 16-20.

The network interface 286 performs network data communication operations of server 120. The network interface 286 includes a physical or wireless connection to a network, such as a local area network, or the Internet. The network interface 286 manages data communications to and from server 120 according to standard network communication protocols, such as hypertext markup language, hypertext transfer protocol, and the Internet Protocol (including the transmission control protocol/Internet protocol).

In some embodiments, the engines are software applications, modules, code, or other programmed data, stored in a digital memory storage device, which can be executed by a processor of server computing device 120 to cause the processor to perform certain operations, as discussed herein.

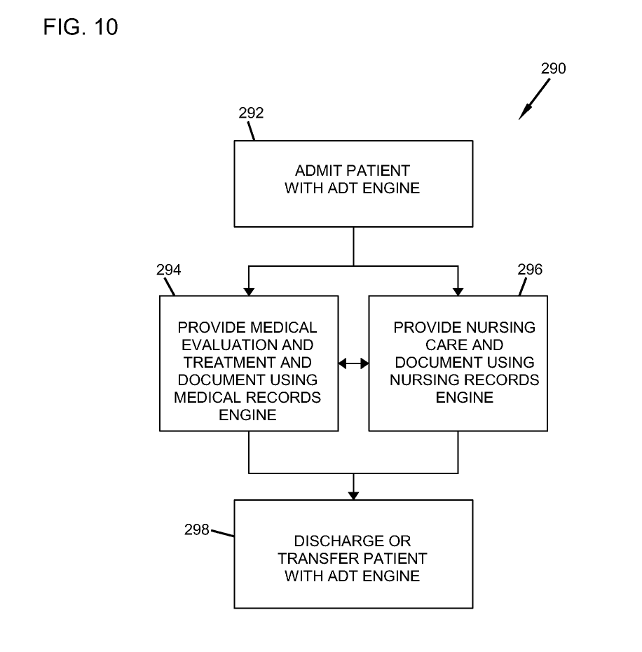

FIG. 10 is a flow chart illustrating an example method 290 of operating server computing device 120. The example method 290 includes operations 292, 294, 296, and 298. The method 290 will be described with reference to the ADT engine 280, the medical records engine 282, and the nursing records engine 284, all shown in FIG. 9.

The method 290 begins with the operation 292 to admit a new patient using the ADT engine 280. The ADT engine 280 generates user interfaces that are displayed to a user who enters information about the new patient, such as the patient's name, date of birth, and chief complaint or reason for the visit. A screen shot of an example ADT engine 280 is illustrated in FIG. 12.

Following admission by the ADT, the operations 294 or 296 are performed. During the operation 294, a physician interacts with the medical records engine 282 to provide medical evaluation and treatment. Data documenting the evaluation and treatment is stored in the patient's medical record by the medical records engine 282.

During the operation 296, a nurse interacts with the nursing records engine 284 to provide nursing care. Data documenting the nursing care is stored in the patient's nursing record by the nursing records engine 284.

The operations 294 and 296 can be performed simultaneously, or as needed. For example, a physician may first evaluate the patient through the operation 294 to provide an initial medical diagnosis. The nurse may then provide care to the patient through the operation 296. The physician and nurse may continue to interact with the medical and nursing records engines 282 and 284 as needed until medical treatment and nursing care has been completed.

Upon completion of the care, the operation 298 is performed to discharge or transfer the patient using the ADT engine 280.

FIG. 11 is a flow chart illustrating an example method 300 of operating the admission, discharge, and transfer (ADT) engine 280. In this example, the method 300 includes operations 302, 304, 306, 308, 310, 312, 314, 316, 318, and 320.

The operation 302 displays a current list of patients that have been admitted to the healthcare facility (which may be a unit, multiple units, a building, or multiple buildings, and may be at a single location or at multiple locations). The current list of patients can be stored in the data store 122 (shown in FIG. 1). The current list of patients is displayed in a user interface, such as by transmitting data from the server 120 to point of care computing device 110. The data is then parsed by point of care computing device 110 to generate the user interface. An example of the ADT engine user interface is shown in FIG. 12.

Upon display of the current patient list, the ADC engine awaits an input from the user. Several possible inputs include an input requesting the admission of a new patient, an input selecting a patient from the current patient list, or an input indicating a desire to transfer or discharge a patient.

The operation 304 receives an input from a user requesting the admission of a new patient. Upon receipt of the new patient input with the operation 306, the ADT engine 280 prompts the user for and retrieves new patient information. The prompting is done through the user interface at the point of care computing device 110, and data identifying the inputs received from the user is transmitted back to the server 120 and the ADT engine 280. Examples of new patient information include the patients name, date of birth, age, physician assigned to the patient, admission diagnosis, admission date, room number, and nurse assigned to the patient.

Upon receipt of the new patient information, the operation 308 adds the new patient to the current patient list, and updates the user interface. The method 300 then returns to the operation 302 to display the updated current patient list.

The operation 310 receives an input from a user selecting a patient from the current patient list. Upon receipt of the selection, the operation 312 determines the user role of the current user, such as whether the user is a physician or a nurse. This is accomplished for example, by requiring the user to login with a username and password, or other identifying and authenticating information. The username is associated with a user role that permits the operation 312 to determine the user role of the current user. If the current user has a user role of physician, the operation 314 is performed to invoke the medical records engine 282 (shown in FIG. 9). If the current user has a user role of nurse, the operation 316 is performed to invoke the nursing records engine 284. As illustrated, the operations 314 and 316 can be performed simultaneously, or in any order.

After the operations 314 and/or 316 have been completed, the method 300 returns to the operation 302 to display the current patient list.

The operation 318 receives an input to discharge or transfer a patient identified in the current patient list. Upon receipt of the input, the operation 320 is performed to remove the patient from the current patient list. The method 300 then returns to the operation 302 to display the updated current patient list.

FIG. 12 is a screen shot of an example user interface 330 for the ADT engine 280, such as displayed on the point of care computing device 110. In this example, the user interface 330 includes a current patient list 332, an Admit Patient control 334, a Discharge/Transfer Patient control 336, a Select Patient control 338, and a Generate Report control 340.

The current patient list 332 displays a list of patients that are currently admitted to the healthcare facility, or unit (or other portion) of a healthcare facility. In this example, the list includes a row that identifies each patient, and columns that include information about that patient. For example, the first line identifies a patient named Amy Judd who is 46 years old, has been assigned to Dr. Sousa as the primary physician, has a medical diagnosis of atrial fibrillation, was admitted on Jan. 1, 2010, is currently assigned to room 401, and is being cared for by nurse Walters. The second line identifies a patient named Sally Smith who is 54 years old, has been assigned to Dr. Rogers, has a diagnosis of supraventricular tachycardia, was admitted on Jan. 2, 2010, is currently assigned to room 402, and is being cared for by nurse Walters. In some embodiments, additional (or different) data is displayed to the nurse. For example, nurse Walters can see the RNDx, RNRx, and orders (RNOx) resulting from the entry of the medical diagnosis (Dx) of atrial fibrillation for patient Judd, or for the medical diagnosis of supraventricular tachycardia for patient Smith.

In some embodiments, the ADT engine 280 includes additional features, such as to provide search, sort, and filtering operations to assist a user in more quickly locating a desired patient in the current patient list 332.

The user can select one of the patients from the current patient list 332 by clicking on the row associated with the patient, or by using up and down arrows until the desired row has been highlighted. One of the controls 334, 336, 338, and 340 can be selected by the user to perform the operation associated with the control.

The Admit Patient control 334 receives an input from a user indicating a desire to admit a new patient to the healthcare facility. Upon receipt of the input, the ADT engine 280 performs operations, such as the operations 306 and 308 shown in FIG. 11.

The Discharge/Transfer Patient control 336 receives an input from a user indicating a desire to admit or transfer the selected patient. Upon receipt of the input, the ADT engine 280 performs operations, such as the operation 320, shown in FIG. 11.

The Select Patient control 338 receives an input from a user to access medical or nursing records associated with the selected patient. Upon receipt of the input, the ADT engine 280 performs operations, such as the operations 312, 314, and 316, shown in FIG. 11.

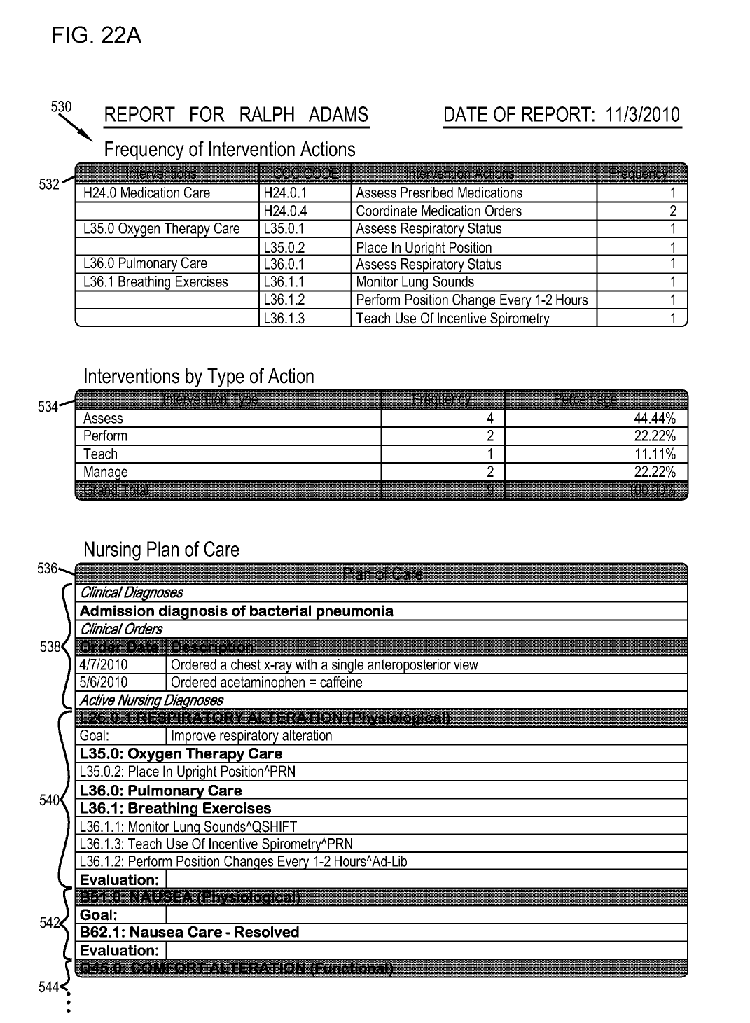

The Generate Report control 340 receives an input from a user indicating that the user wants to generate a report. The report may be for the selected patient, or may be general reports relating to the healthcare facility or unit. Several examples of reports are illustrated in FIGS. 22-24.

FIG. 13 is a schematic block diagram of an example medical records engine 282 of the server computing device 120. In this example, the medical records engine 282 includes the intelligent prompting engine 350 and the note generator engine 352. The medical records engine 282 utilizes the medical terminology 128 of the knowledge base 124 and the medical record 132 of the patient records 126.

The medical records engine 282 provides the interface between the physician and the electronic health records system 106. It assists the physician in numerous ways, such as by automatically suggesting medical findings and diagnoses, which both increases the speed of data entry by the physician, but also improves the quality of care by automatically prompting the physician with relevant information based on the medical findings that have previously been entered in the patient's medical record 132 or based on findings from the current patient encounter. The medical records engine 282 then generates and maintains the medical record 132, such as to include the physicians findings from the patient encounter.

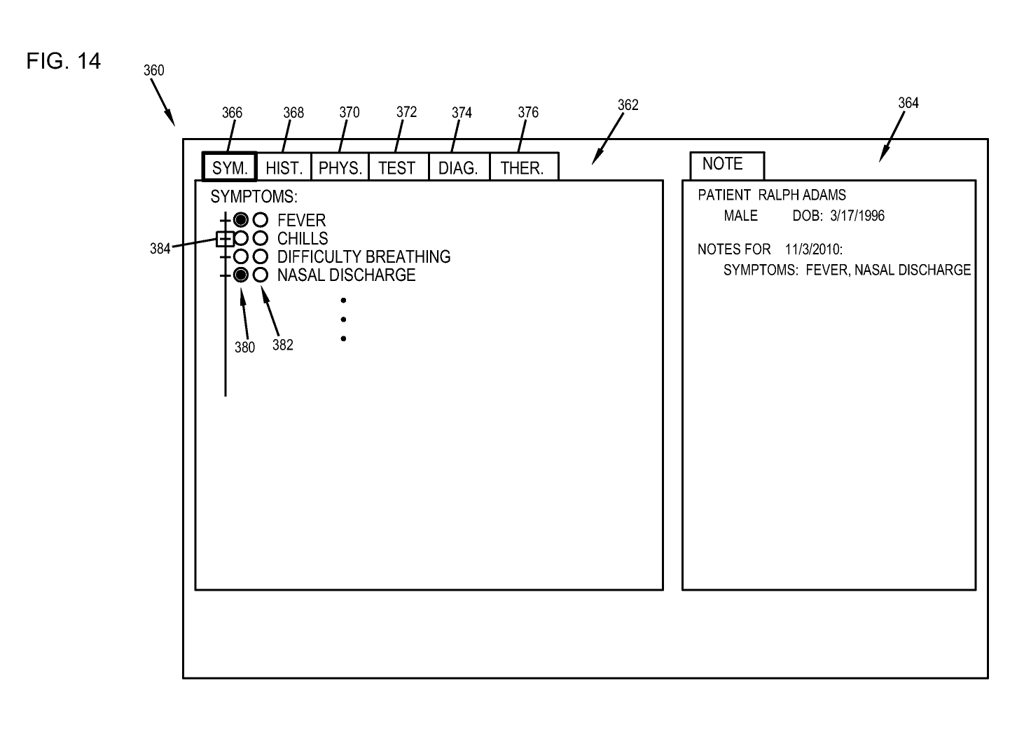

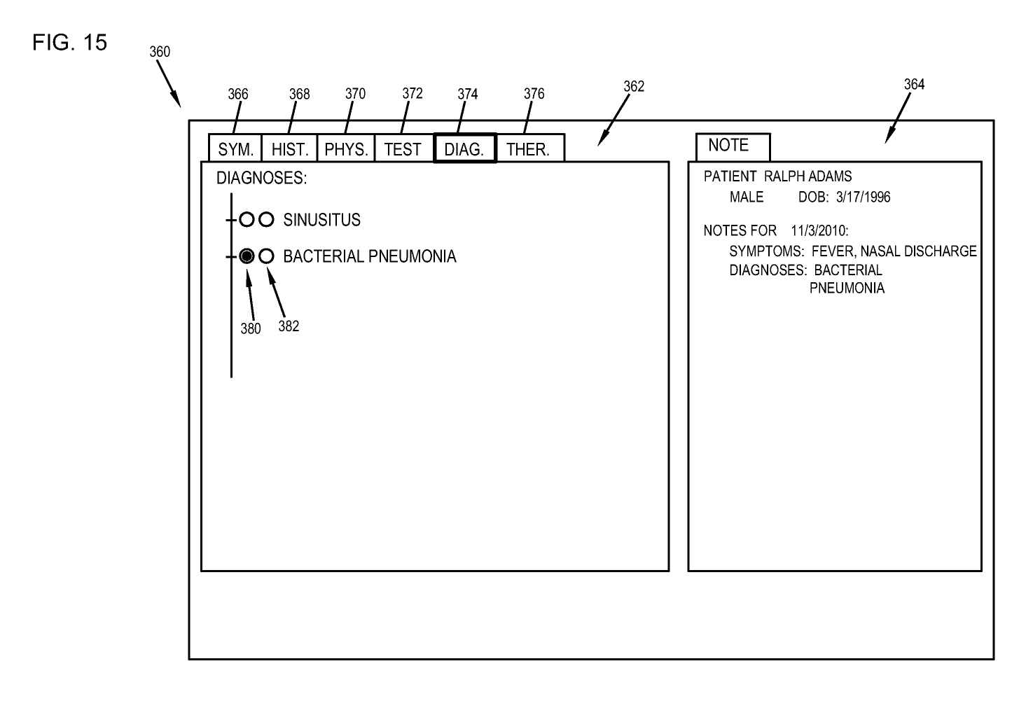

The intelligent prompting engine 350 generates data defining a user interface, and provides the intelligent prompting operations to guide the physician through the documentation of the patient encounter. Examples of intelligent prompting systems and methods, and user interfaces, are described in U.S. Pat. No. 5,823,949, titled Intelligent Prompting, issued on Oct. 20, 1998, and in U.S. Ser. No. 12/817,050, titled Caregiver Interface For Electronic Medical Records, filed on Jun. 16, 2010, the entire disclosures of which are hereby incorporated by reference. An example user interface including the intelligent prompting are also illustrated in FIGS. 14-15.

The note generator engine 352 generates patient notes that document a current patient encounter, including the physician's findings from the encounter. The patient notes are then stored in the patient's medical record 132 of data store 122.

FIGS. 14-15 illustrate an example user interface generated by medical records engine 282 for documenting or reviewing a patient note of the patient's medical record. FIG. 14 is a screen shot of an example user interface 360 illustrating the intelligent prompting of the patient's symptoms and generation of the patient note. FIG. 15 is a screen shot of an example user interface 360 illustrating the intelligent prompting of the patient's diagnosis and further generation of the patient note.

As shown in FIG. 14, user interface 360 includes a documentation window 362 and a patient note window 364. The documentation window 362 includes a plurality of selectable tabs 366, 368, 370, 372, 374, and 376. Selectable controls are also provided, including positive controls 380 and negative controls 382.

The documentation window 362 interacts with the physician to document the current patient encounter. In this example, documentation window 362 includes a plurality of selectable tabs for documenting different aspects of the patient encounter. The selectable tab 366, which is currently selected in the user interface 360 illustrated in FIG. 14, is selected to document symptoms. The selectable tab 368 is selected to document history. The selectable tab 370 is selected to document physical examination findings. The selectable tab 372 is selected to order tests and document test results. The selectable tab 374 is selected to make a diagnosis. The selectable tab 376 is selected to order therapies or document the results of therapies.

In this example, the symptoms tab 366 is selected, and therefore documentation window 362 prompts the physician to identify the patient's symptoms. The intelligent prompting engine 350 (shown in FIG. 13) utilizes the medical terminology 128 to suggest possible symptoms. In some embodiments the symptoms are grouped or otherwise arranged, such as into a hierarchy, to assist the physician in more quickly identifying relevant symptoms. In some embodiments relevant symptoms are automatically suggested to the physician based on the findings already entered, the patient's medical history, the diagnosis, or other information. If the patient is admitted with an admission diagnosis, the admission diagnosis can be used as a starting point for identifying possible symptoms. Keyword search features can also be provided to assist the physician in quickly locating a specific symptom, or alternatively the physician can simply type (or otherwise input, such as via voice) the symptom, which is then located in the medical terminology.

In the example user interface 360, a variety of possible symptoms are displayed, including Fever, Chills, Difficulty Breathing, and Nasal Discharge. Each symptom is associated with a pair of selectable controls arranged in two rows. The selectable controls 380 in the first column are a set of selectable controls that can be used to indicate that the respective symptom was identified (a positive finding) in the current encounter. The selectable controls 382 in the second column are a set of selectable controls that can be used to indicate that the symptom was not identified (a negative finding) in the current encounter. In some embodiments the selectable controls are displayed in different colors. For example, selectable controls 380 in the first column are red and selectable controls 382 in the second column are blue. Other colors are used in other embodiments. In some embodiments, the selectable controls 380 in the first column are visually distinguishable from the selectable controls 382 in the second column.

In some embodiments the terms are arranged in a tree structure. Terms having additional children terms are indicated by a selectable tree control 384. The user can select the selectable tree control 384 to expand the display to show the children terms, or if the levels are already displayed, can select the selectable tree control 384 to hide the children terms.

In this example, the physician has selected the controls 380 in the first column associated with Fever and Nasal Discharge to indicate that both symptoms were positively identified during the patient encounter.

As the physician enters the findings in the documentation window 362, the patient note window 364 displays the current patient note associated with the present encounter. In this example, the patient note window 364 identifies the patient as Ralph Adams, who is a male, with a date of birth of Mar. 17, 1996. Below the patient identification is data summarizing the current medical findings, including the symptoms of Fever and Nasal Discharge.

FIG. 15 illustrates the example user interface 360 after selection of the diagnosis tab 374. The diagnosis tab 374 is selected to review the suggested diagnoses and to select a diagnosis for the patient. As noted above, user interface 360 includes a documentation window 362 and a patient note window 364.

In this example, the physician selects the diagnosis tab 374 after having entered the symptoms of Fever and Nasal Discharge, as shown in FIG. 14. The physician may also, or alternatively, enter other medical findings by selecting the history tab 368, the physical findings tab 370, the tests tab 372, and the therapies tab 376.

Upon selection of diagnosis tab 374, the intelligent prompting engine 350 (shown in FIG. 13) searches through medical terminology 128 of knowledge base 124 (shown in FIGS. 1 and 5) to identify a set of possible diagnoses based on the current medical findings, such as the symptoms of Fever and Nasal Discharge.

Through this search, the intelligent prompting engine 350 identifies a set of diagnoses associated with these symptoms, and those diagnoses are displayed in documentation window 362. In this example, the diagnoses include Sinusitus and Bacterial Pneumonia.

Selectable controls displayed next to each diagnosis permit the physician to select the diagnosis. By selecting the control 380 in the first column, the physician can select the diagnosis as being a positive for the current patient. By selecting the control 382 in the second column, the physician can select the diagnosis as being negative for the current patient.

In the example illustrated in FIG. 15, the physician has selected the diagnosis of Bacterial Pneumonia for the patient. Accordingly, the patient note window 364 is updated to display the patient's diagnosis.

FIG. 16 is a schematic block diagram of an example nursing records engine 284 of the server computing device 120. In this example, the nursing records engine 284 includes an initial data entry engine 390, a plan of care engine 394, and a note generator engine 396. In this example, the initial data entry engine 390 utilizes an intelligent prompting engine 392. The nursing records engine 284 utilizes the medical record 132 and the nursing record 134 from the patient's record 126, shown in FIG. 1.

The nursing records engine 284 provides the interface between the nurse and the electronic health records system 106. It assists the nurse in numerous ways, such as by automatically identifying a nursing diagnosis based on the patient's medical record, developing the plan of care, and documenting nursing care that is provided to the patient and saving the results in nursing record 134.

The operation of nursing engine 284 typically proceeds from the initial data entry engine 390, in which the plan of care is developed, to the plan of care engine 394 that monitors and tracks the progress on the plan of care. The note generator engine 396 documents the results in the nursing record 134.

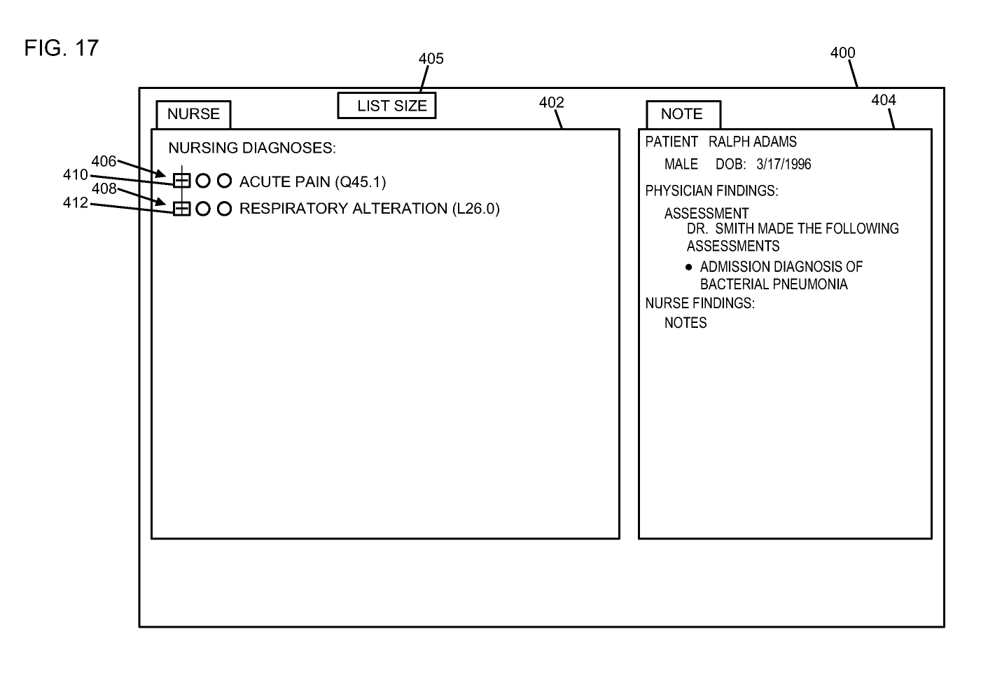

The initial data entry engine 390 generates a user interface to guide the nurse through initial data entry for a patient, to develop the patient's initial plan of care. An example of a user interface generated by the initial data entry engine 390 is illustrated in FIGS. 17-19.

In some embodiments, the initial data entry engine 390 includes the intelligent prompting engine 392. The intelligent prompting engine 392 utilizes the structured nursing terminology 130, such as illustrated in FIG. 6, to intelligently suggest to the nurse medical terms associated with the patient's condition. For example, the intelligent prompting engine retrieves from the patient's medical record 132 the current medical findings, which may include symptoms, physical examination findings, test results, medical diagnoses, etc. Based on those medical findings, the intelligent prompting engine 392 performs a search across diagnoses tables 242 (shown in FIG. 6), to identify a set of one or more diagnoses that include the medical findings. If the resulting set is large, the set can be filtered to include or display only those that are most closely correlated to the medical findings. In some embodiments, the nursing diagnoses are automatically selected based on importance ratings included in the diagnoses tables 242.

The intelligent prompting engine then continues to prompt the nurse to generate the plan of care, such as by suggesting a set of nursing interventions associated with the selected one or more diagnoses, and further suggesting a set of nursing orders associated with the selected one or more diagnoses. The diagnoses, interventions, and orders are selected to define the plan of care for the patient.

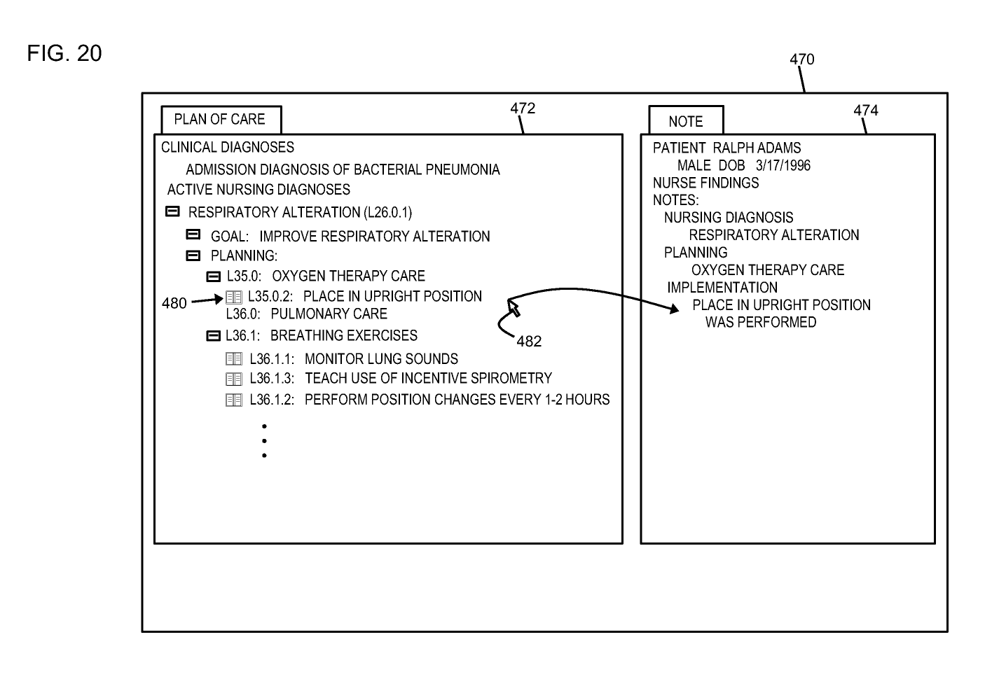

Once the plan of care has been generated, the plan of care engine 394 operates to display the plan of care to nurses, monitor the progress through the plan of care, and make a record of the nursing care and results. A screen shot of an example user interface generated by the plan of care engine 394 is illustrated in FIG. 20.

The note generator engine 396 operates to generate patient notes describing the nursing care, and to record the patient notes in the nursing record 134 of the patient record 126.

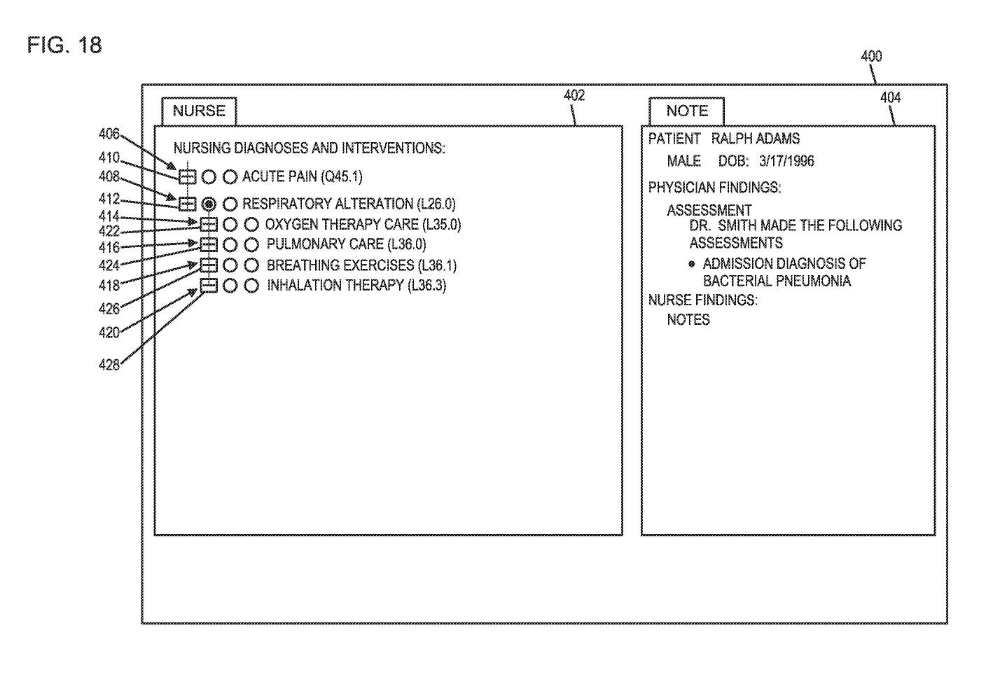

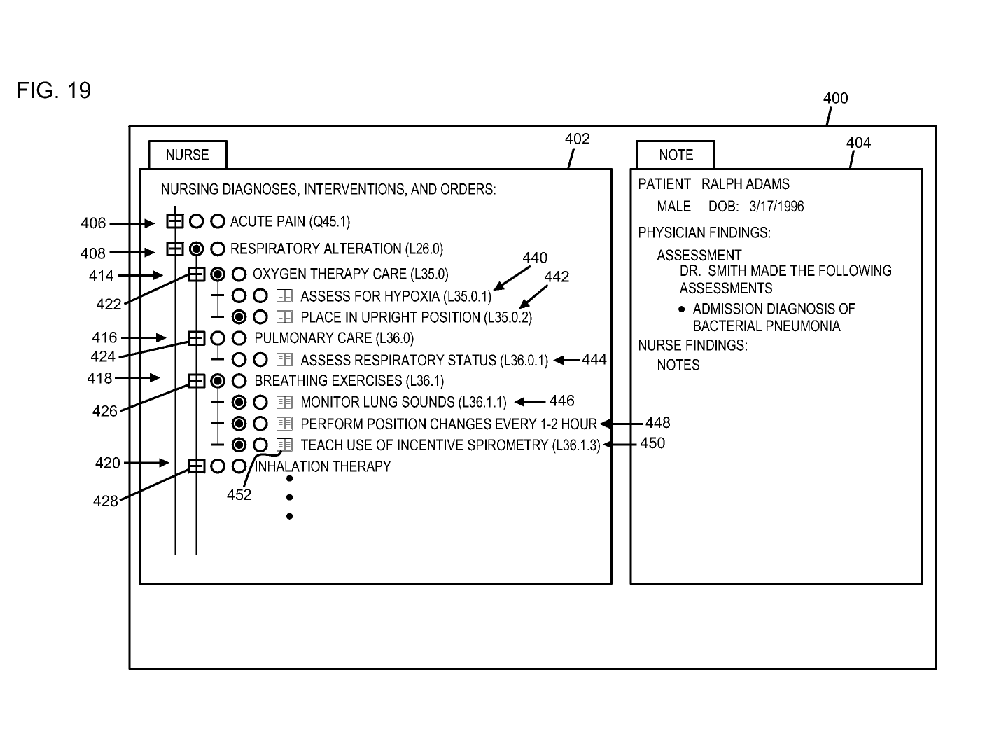

FIGS. 17-19 are screen shots illustrating the development of a nursing plan of care utilizing an example user interface 400 generated by the initial data entry engine 390. FIG. 17 is a screen shot in which nursing diagnoses are displayed. FIG. 18 is a screen shot in which nursing diagnoses and interventions are displayed. FIG. 19 is a screen shot in which nursing diagnoses, interventions, and orders are displayed.

Referring now to FIG. 17, the example user interface 400 includes a plan of care development window 402 and a patient note window 404. In an example embodiment, data is generated by the nursing records engine 284, transmitted to the point of care computing device 110 across a communication network, and displayed, for example, on a point of care computing device 110, shown in FIG. 1.

The plan of care development window 402 displays to the nurse a set of suggested nursing terms. The nurse interacts with plan of care development window 402 to select the desired nursing terms, which are then saved as the plan of care.

The patient note window 404 displays a patient note for the current patient. In some embodiments the patient note window 404 displays data from the medical record 132, so that the nurse can view that information while generating the plan of care. In some embodiments, the patient note window 404 displays data from both the medical record 132 and the nursing record 134, or alternatively, only data from nursing record 134.

In this example, the patient has already been examined by physician Dr. Smith, and Dr. Smith found that the patient had Bacterial Pneumonia. Based on the medical diagnosis, and possibly other data in the patient's medical record, the intelligent prompting engine 392 of the initial data entry engine 390 (shown in FIG. 16) automatically identifies a set of one or more nursing diagnoses associated with the medical findings and diagnosis of Bacterial Pneumonia, which are then displayed in the plan of care development window 402. In this case, the nursing diagnoses are Acute Pain and Respiratory Alteration, as displayed in rows 406 and 408. This indicates that, based on the patient's medical record, the types of care most likely to be needed by the patient are to help manage his pain and to attempt to alter his respiratory system in some manner.

The nursing terms displayed in plan of care development window 402 are displayed in a contextual hierarchical tree structure to permit the nurse to quickly and easily identify the relevant nursing terms, and to select the desired nursing orders to be incorporated into the plan of care. In this example, the tree structure is displayed through the use of selectable controls 410 and 412 displayed adjacent to the nursing terms. The selectable controls 410 and 412 are displayed when a term in the hierarchy is associated with children terms. The children can be displayed or hidden by selecting the selectable controls 410 or 412.

Additional information associated with the nursing terms can also be displayed, if desired, such as the clinical care classification code associated with the nursing term, or other information.

Some embodiments of the user interface 400 include a list size selectable control 405. The list size selectable control can be selected by the user to adjust the amount of data displayed in the plan of care development window 402. For example, upon selecting the list size selectable control 405, a dropdown menu is displayed that includes the numbers 1, 2, and 3. Or, in another embodiment, terms such as “short,” “moderate,” and “detailed” are displayed. The user selects the number or term to adjust the amount of information displayed. For example, if 1 (or “short”) is selected, the plan of care development window 402 displays only those nursing diagnoses that are most important to the physician's findings. The importance can be determined by the electronic health records system 106 by referring to the importance ratings 268, shown in FIG. 7, for example. If 3 (or “detailed”) is selected, all of the possible nursing diagnoses are displayed that are related to the physician's findings. The list size feature can similarly be included in other user interfaces described herein to allow the user to adjust the amount of detail displayed in a user interface.

FIG. 18 illustrates the further display of nursing interventions along with the nursing diagnoses. Upon selection of the selectable control 412, the set of nursing interventions associated with the Respiratory Alteration diagnosis (row 408) is displayed in plan of care development window 402. The nursing interventions include Oxygen Therapy Care, Pulmonary Care, Breathing Exercises, and Inhalation Therapy (rows 414, 416, 418, and 420).

To further display portions of the hierarchical tree structure, selectable controls 422, 424, 426, and 428 are provided that can be selected to display or hide nursing orders associated with the respective nursing interventions.

FIG. 19 illustrates the further display of nursing orders along with the nursing interventions. Upon selection of selectable controls 422, 424, 426, and 428, nursing orders associated with the nursing interventions are displayed in plan of care development window 402.

In this example, nursing orders include Assess For Hypoxia (row 440), Place in Upright Position (row 442), Assess Respiratory Status (row 444), Monitor Lung Sounds (row 446), Perform Position Changes Every 1-2 Hours (row 448), Teach Use of Incentive Spirometer (row 450). A graphical element 452 can be displayed in association with the nursing orders, in some embodiments.

A tree structure is graphically depicted in the user interface to assist the user in visualizing the structure of the nursing terms. The nursing diagnoses at rows 406 and 408 are shown positioned toward the left side of window 402, and vertically above other nursing terms. Lines extending downward from the selectable controls also visually represent the relationship between terms. For example, the nursing diagnosis of Respiratory Alteration at row 408 has a vertical line extending down from the associated selectable control, which indicates that all of the nursing terms positioned to the right of the vertical line are associated with the Respiratory Alteration nursing diagnosis. For example.

Each of the nursing interventions are graphically depicted as being indented to the right in window 402, and have selectable controls 422, 424, 426, and 428 that are aligned along a second vertical line. The second vertical line again depicts the relationship between the nursing interventions and additional nursing terms, such as the nursing operations. For example, the nursing intervention of Oxygen Therapy Care at row 414 has a selectable control 422. The two nursing operations of Assess For Hypoxia (row 440) and Place in Upright Position (row 442) are visually depicted as being related to Oxygen Therapy Care by being positioned below and further indented to the right from the nursing intervention that they are related to.

In some embodiments, each nursing term further includes at least one selectable control that can be used to indicate that the respective nursing term should be included in the plan of care for the patient. In the example illustrated in FIG. 19, a user has selected the nursing diagnosis of Respiratory Alteration (row 408) for inclusion in the plan of care. Within the nursing diagnosis, the user has selected nursing interventions of Oxygen Therapy Care (row 414) and Breathing Exercises (row 418) for inclusion in the plan of care. Within the nursing intervention of Oxygen Therapy Care (row 414), the user has selected the nursing order of Place in Upright Position (row 442) for inclusion in the plan of care. The user has also selected nursing orders associated with the nursing intervention of Breathing Exercises (row 418) including Monitor Lung Sounds (row 446), Perform Position Changes Every 1-2 Hours (row 448), and Teach Use of Incentive Spirometer (row 450) for inclusion in the plan of care. Each nursing operation further has an associated set of actions associate with it, in some embodiments, which are automatically included in the plan of care upon selection of the nursing order.

In some embodiments, nursing orders can be standard nursing orders or custom nursing orders. In some embodiments a graphical element 452, such as an icon, are displayed in association with nursing orders in window 402 to indicate whether the order is a standard order or a custom order. For example, in some embodiments graphical element 452 is displayed with a first color (e.g., blue) if the nursing order is a standard order, and a second color (e.g., green) if the nursing order is a custom order. Other embodiments represent standard and custom orders in other ways, such as using different fonts, font types, icons, graphics, or other visually distinguishable representations.

As discussed herein, when a custom order has been defined for a particular order, only the custom order is typically displayed in window 402. In other words, the custom order overrides the standard order. However, in another possible embodiment, both custom and standard orders are displayed, and the user can select between the two. In some embodiments a warning, caution, or alert message is displayed to confirm a user's decision to use a standard order rather than a custom order.

In some embodiments, a step in the development of the plan of care is to define a goal for the care. In some embodiments the goal is associated with the nursing diagnosis. For example, when the diagnosis of Respiratory Alteration is selected, the user is then prompted to select a goal from the options of Improve, Stabilize, or Support. If the user selects, for example, Improve, then the plan of care is associated with the goal of Improve Respiratory Alteration. The goal is then displayed in the plan of care, such as shown in FIG. 20 to assist the nurses in understanding the goal of the nursing care for this patient. The plan of care and goals for the care can be adjusted at any time as necessary to respond to the changing condition of the patient, such as by returning to the user interface 400.

FIG. 20 is a screen shot of an example user interface 470 for implementing the plan of care for a patient, such as generated by the plan of care engine 394, shown in FIG. 16. The plan of care is defined by a nurse, for example, as illustrated in FIGS. 17-19.

In this example, user interface 470 includes a plan of care window 472 and a patient note window 474. The plan of care window 472 displays the plan of care for the patient. The patient note window 474 displays the current patient note for the patient.

The items listed in the plan of care are selectable to view more information, or to indicate that an action was performed relating to the item. For example, upon reviewing the plan of care, a nurse sees the nursing order to Place in Upright Position (item 480). Accordingly, the nurse performs the actions associated with the nursing order. Upon completion of the actions, the nurse provides an input to the user interface 470 to indicate that the order has been completed. For example, using a pointer 482, the nurse clicks on the order for Place in Upright Position (item 480), and drags the order from the plan of care window 472 to the patient note window 474. The patient note in patient note window 474 is then updated to reflect that the order has been implemented for the patient in accordance with the plan of care. In some embodiments the plan of care is updated to indicate that the order has been completed, such as by displaying a check mark next to the order, or by removing the order from the plan of care window 472. In this way the user interface 470 distinguishes between orders that have been completed and orders that still need to be completed, to permit a nurse to determine what orders remain to be performed for the patient to complete the plan of care.

FIG. 21 is a screen shot of an example user interface 490 illustrating a combined view in which medical data and nursing data are visible simultaneously in the user interface 490. The user interface 490 includes the medical data window 492 and the nursing data window 494.

The medical data window 492 is provided in the user interface 490 to display medical data, and to receive inputs from a physician. In some embodiments, the medical data window 492 is the same or similar to the documentation window 362, discussed herein. For example, the medical data window 492 includes, in some embodiments, tabs associated with various medical findings, such as symptoms (tab 502), history (tab 504), physical examination (tab 506), tests (tab 508), diagnoses (tab 510), and therapies (tab 512). The tabs are selectable by the user to view the respective portions of the medical findings, or to permit entry of the medical findings associated with the current encounter.

In the illustrated example, the physician has already selected a diagnosis for the current patient of Bacterial Pneumonia 520, and the user has selected tab 508 to view a list of tests that could be performed associated with bacterial pneumonia. The tests are automatically selected by the electronic health records system 106, in some embodiments, based on the medical diagnosis 520, or based on other findings from the patient's medical record.

In some embodiments, the medical data window 492 displays part or all of the medical record 132 (shown in FIG. 1) for the patient. In another possible embodiment, medical data window 492 displays medical terms.

The user interface 490 further includes a nursing data window 494, which is provided to display nursing data, and to receive inputs from a nurse regarding nursing care. Upon selection of the medical diagnosis 520 by the physician, the nursing data window 494 is automatically updated, as represented by an arrow 529, to display the available nursing terms that are associated with the medical diagnosis 520. In this example, the nursing diagnoses associated with Bacterial Pneumonia include Acute Pain 522 and Respiratory Alteration 524.

In some embodiments the nursing data window 494 displays a nursing plan of care. In another possible embodiment, the nursing data window 494 displays part or all of the nursing record 134 (shown in FIG. 1) for the patient. In another possible embodiment, nursing data window 494 displays nursing terms.

In some embodiments, the user interface 490 can be viewed by either a physician user or a nurse user, to simultaneously view both medical data and nursing data for the current patient. The data can include data for the current encounter, past medical or nursing data, or possible future medical or nursing data (such as a set of tests that could be performed, or a set of nursing orders that could be performed).

The combined medical and nursing data available through the user interface 490 permits the nurse and the physician to see what the other is doing. For example, it permits the physician to view the nursing plan of care to see what orders the nurse has completed or is planning to complete. In some embodiments it permits the physician to view the nursing terms associated with medical findings, such as to permit the physician to make suggestions on appropriate care to be provided to the patient. In some embodiments it permits the physician to view the nursing records, to view the results of nursing care (e.g., review the vital signs measured by the nurse). Similarly, the combined view provides the nurse with information about what the physician has found, what the physicians plans are for the given patient, test results, or other medical information.

FIGS. 22-24 illustrate example reports generated by the electronic health records system 106. For example, FIG. 12 illustrates the selectable control 340 of the ADT user interface 330 that can be selected to initiate a report generator engine. The report generator engine can access data stored in the data store 122 (shown in FIG. 1) to collect, compile, and format the data into a variety of different reports. Several example reports are illustrated in FIGS. 22-24.

FIG. 22 (including FIGS. 22A and 22B) is an example of an individual patient report of nursing care 530, which can be generated, for example, by the electronic health records system 106. In this example, the report 530 includes several sections, including a frequency of intervention actions section 532, an interventions by type of action section 534, and a nursing plan of care section 536. Although the example shown in FIG. 22 is specifically directed to nursing care, medical data can also or alternatively be included in the report, in other possible embodiments.

Report 530 identifies the name of the patient that the report relates to, such as Ralph Adams. The report may also provide additional information about the patient, such as the patient's date of birth, or other information. The date and time that the report was generated can also be provided.

The section 532 of the report 530 provides a list of nursing interventions that have been performed for the patient, and the frequency that each intervention has been performed. The interventions include Medication Care, Oxygen Therapy Care, Pulmonary Care, and Breathing Exercises.

For each nursing intervention (RNRx), the specific nursing orders (RNOx) that have been performed are also identified in some embodiments. For example, the intervention of Medication Care includes two orders that have been performed, namely Assess Prescribed Medications and Coordinate Medication Orders. The section 532 indicates that the Assess intervention action type has been performed once, and the Coordinate intervention action type has been performed twice. The CCC code is also displayed for the interventions and actions in some embodiments.

The section 534 provides a list of nursing intervention action types that have been performed, and the frequency that each intervention action type has been performed. In addition, the frequency that each intervention action type has been performed is displayed as a percentage of the frequency of all intervention action types.

In this example, four Assess intervention action types have been performed, accounting for 44.44% of the intervention action types; two Perform intervention action types have been performed, accounting for 22.22% of all intervention action types; one Teach intervention action type has been performed, accounting for 11.11% of the intervention action types; and 2 Manage intervention action types have been performed, accounting for 22.22% of the intervention action types.

In some embodiments, orders are associated with average amounts of time required to complete the orders. Accordingly, another possible embodiment generates a report that identifies the average amount of time spent for each action type, and lists the percentage of time that each action type consumed of the total time of nursing care. The total amount of time required for nursing care is also included in report 530 in some embodiments. In some embodiments time values can be customized by the healthcare facility.

The section 536 provides a report on the nursing plan of care that was generated for the patient. The plan of care includes a variety of information about the plan of care, such as a medical data section 538, and nursing diagnoses sections 540, 542, 544, 546, and 548.

The medical data section 538 includes, for example, a summary of the medical diagnosis and medical orders from the physician. In this example, the medical data section 538 of the report 530 indicates that the patient was admitted with a diagnosis of bacterial pneumonia, and that the physician ordered a chest x-ray on Apr. 7, 2010, and prescribed treatment of acetaminophen with caffeine on May 6, 2010.

Nursing care is then summarized according to each nursing diagnosis. The section 540 provides a summary of care provided relating to the Respiratory Alteration diagnosis. The section 540 indicates that a goal of improving respiratory alteration was identified, and that three nursing interventions were planned including Oxygen Therapy Care, Pulmonary Care, and Breathing Exercises. For each intervention, a list of nursing orders that were planned is also displayed.

The section 542 identifies the second nursing diagnosis of Nausea, and indicates that the Nausea Care intervention was resolved.

The section 544 indentifies the third nursing diagnosis of Comfort Alteration, and indicates that Chronic Pain Control was planned.

The sections 546 and 548 similarly summarize additional nursing diagnoses (RNDx), interventions (RNRx), and orders (RNOx). As shown, in some embodiments the sections identify goals and the evaluation of the outcome relative to the goal indicating whether the goal was successfully achieved or whether the care did not achieve the desired goal.

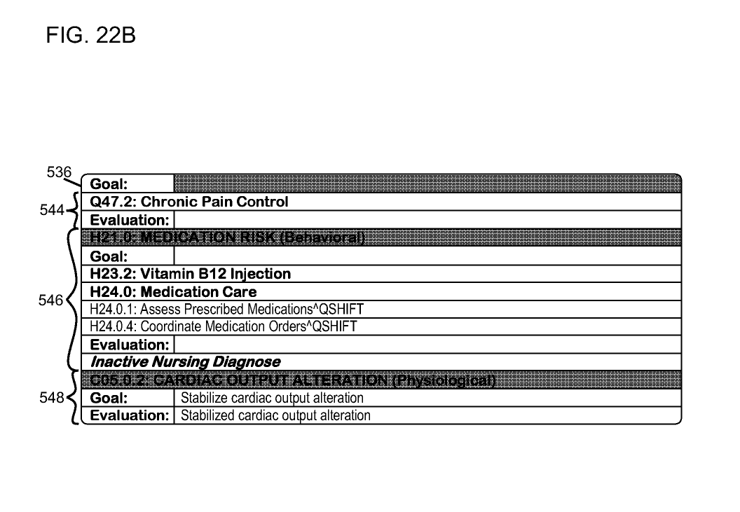

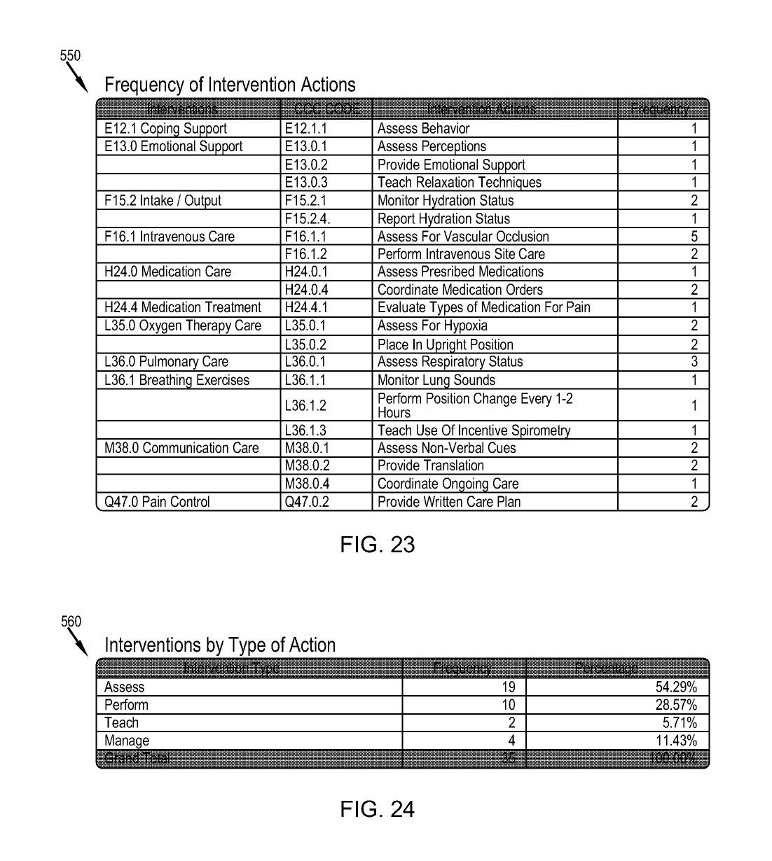

FIGS. 23 and 24 illustrate additional examples of reports that can be generated by the electronic health records system 106, and more specifically examples of aggregate reports that can be generated based on a combination of nursing data from multiple patients.

FIG. 23 is an example report 550 that identifies the frequency of intervention actions types across a set of patients. The set of patients may be, for example, all patients within a particular unit that were present on a given day. The set of patients may also be, for example, the set of all patients within the medical facility. The report is generated based upon the nursing interventions that have occurred within a period of time, such as an hour, a day, a set of days, a month, a quarter, a year, or any portion or collection of these periods of time.

The report 550 provides a list of all nursing interventions that have been provided to the set of patients, such as Coping Support, Emotional Support, Intake/Output, Intravenous Care, etc. For each nursing intervention, nursing orders that have been completed that are associated with the nursing intervention are displayed, in some embodiments, such as Assess Behavior (one occurrence) for Coping Support, and Assess Perceptions (one occurrence) and Provide Emotional Support (one occurrence) for Emotional Support, etc.

Average time data can also be included in some embodiments to show the amount of time required for each nursing intervention and each nursing order. Percentages of time required by nursing orders are also included in report 550 in some embodiments. In some embodiments time values can be customized by the healthcare facility.

FIG. 24 is an example report 550 identifying nursing interventions that have been provided by type of nursing intervention action type. The example report 550 indicates that nineteen Assess nursing intervention action types have been performed, ten Perform nursing intervention action types, two Teach nursing intervention action types, and 4 Manage nursing intervention action type. The respective percentages of the frequency of each nursing intervention action type to the total number of nursing intervention action types are also displayed.

Average time data is also used in some embodiments to indicate the approximate amount of time required for nursing care to provide each type of action, and the percentage of the time spent on each type of action. In some embodiments time values can be customized by the healthcare facility.

The reports illustrated in FIGS. 22-24 are only several of the many possible reports that can be generated by the report generator engine in the various embodiments according to the present disclosure, such as utilizing any of the data in the data store 122, or other data.

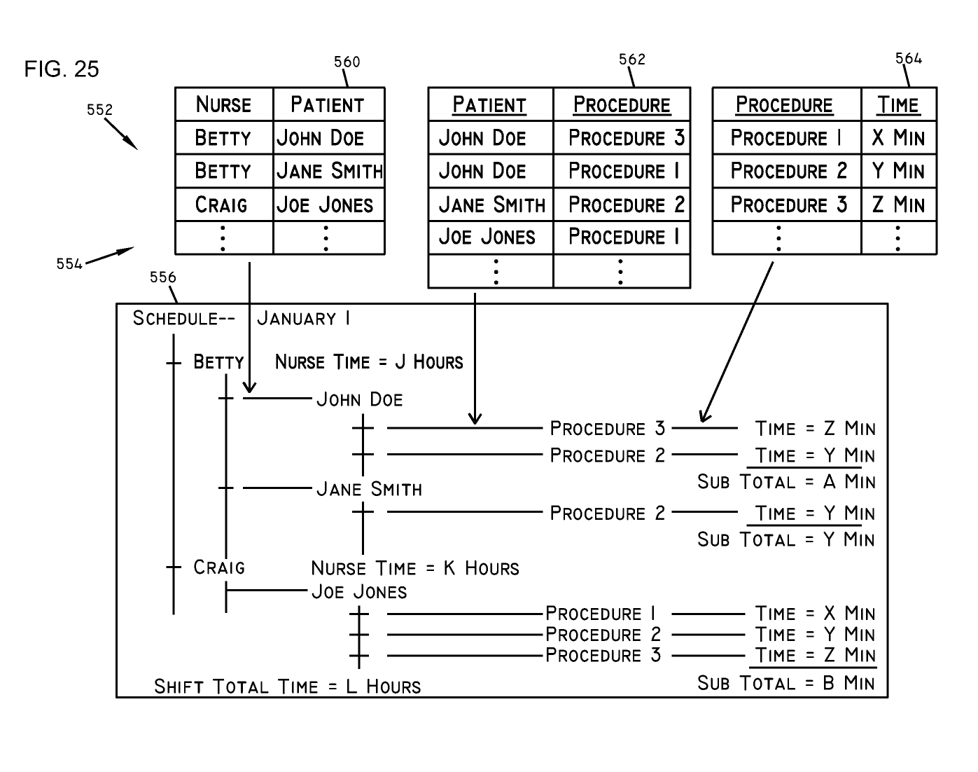

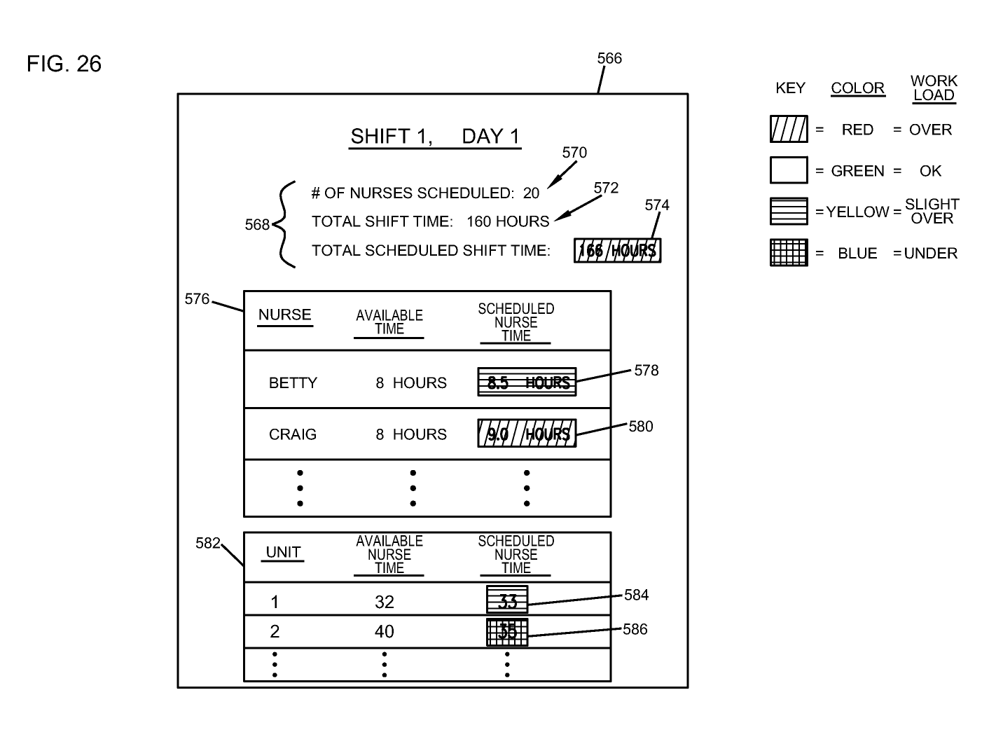

FIGS. 25-26 illustrate an example embodiment of a nurse scheduling engine 552. In this example, the nurse scheduling engine 552 utilizes data tables 554 to generate a nursing schedule 556.

Data tables 554 are used in one embodiment to store the data utilized by the nurse scheduling engine 552. In this example, data tables 554 store nurse scheduling data, such as in a nurse assignment table 560, patient procedure table 562, and procedure time table 564.

The nurse assignment table 560 identifies the nurse or nurses that are assigned to a particular patient. In the example shown in FIG. 25, nurse Betty is assigned to two patients, including John Doe and Jane Smith. Nurse Craig is assigned to patient Joe Jones.

In some embodiments, the nurse assignment table 560 is associated with a particular nursing shift. For example, the nursing table 560 is for a first shift, which indicates that nurse Betty is assigned to John Doe for the first shift. A second table, similar to table 560, identifies a second nurse that is assigned to the patient John Doe for the second shift. In some embodiments, the nurse assignment table is associated with a particular hour, day, or other period of time.

The patient procedure table 562 identifies the procedures that are to be performed on patients that involve action by the nurse. In this example, patient procedure table 562 indicates that patient John Doe is going to have Procedure 3 and Procedure 1 performed, Patient Jane Smith is going to have Procedure 2 performed, and Patient Joe Jones is going to have Procedure 1 performed. In some embodiments, the patient procedure table 562 identifies a particular time that the procedure should be completed, or a range of times for the procedure to be completed. An example of a procedure is a nursing order. Nursing orders are described in more detail herein.

The procedure time table 564 identifies the estimated duration of time that is required to complete the various procedures. In this example, Procedure 1 is estimated to take X minutes, Procedure 2 is estimated to take Y minutes, and Procedure 3 is estimated to take Z minutes. Another example of the procedure time table 563 is the nursing order time chart 270, shown in FIG. 8.

Using the data tables 556, the nurse scheduling engine 552 generates nurse schedule 556. In some embodiments, the nurse schedule 556 is a user interface displayed on a computing device.

In this example, the nurse schedule 556 displays the nursing schedule for a particular period of time, such as the day January 1. Other periods of time are used in other embodiments, such as minutes, hours, shifts, days, weeks, months, etc.

The nurse schedule 556 for January 1 indicates that Betty and Craig are both scheduled to work that day, and that nurse Betty is assigned to patients John Doe and Jane Smith. This data is obtained by the nurse scheduling engine 552, for example, from nursing assignment table 560.

The nurse schedule 556 also indicates the nursing procedures that each nurse will be performing for the assigned patients on this day. In this example, nurse Betty will be performing Procedure 3 and Procedure 2 on John Doe, and Procedure 2 on Jane Smith. Nurse Craig will be performing Procedure 1, Procedure 2, and Procedure 3 on patient Joe Jones. This data is obtained by the nursing engine 552, for example, from patient procedure table 562.

The nurse schedule also indicates the duration of time that will be required for each procedure. John Doe's procedures will require Z minutes and Y minutes, respectively; Jane Smith's procedure will require Y minutes; and Joe Jones's procedures will require X minutes, Y minutes, and Z minutes, respectively.

In some embodiments, patient time subtotals are provided. For example, the estimated subtotal of the time required by nurse Betty to complete John Doe's procedures is A minutes (equal to Z+Y minutes); the estimated subtotal of time required by nurse Betty to complete Jane Smith's procedure is Y minutes; and the estimated subtotal of time required by nurse Craig to perform Joe Jones's procedures is B minutes (equal to X+Y+Z minutes). This data is obtained by the nursing engine 552, for example, from procedure time table 564. In some embodiments, the subtotals include a transition time in addition to the sum of the procedure times. The transition time provides additional time for unexpected events, as well as a period of time to transition from one procedure to another procedure. For example, if a transition time T is used, the procedure B subtotal can be computed as (X+T)+(Y+T)+(Z+T). In other embodiments, the transition time is included within the procedure times in table 564.

In some embodiments, the nurse scheduling engine 552 computes the total estimated duration of time that is required for each nurse to complete the procedures that the nurse is assigned to perform. In this example, nurse Betty is scheduled to work for a total of J hours, which is calculated as the sum of the patient time subtotals. For example, Nurse Betty's total time is the sum of A minutes+Y minutes, and Nurse Craig's total time (K) is B minutes.

The total shift time is also computed by nurse scheduling engine 552 in some embodiments. The shift time total is computed, for example, as the sum of the nurse total times. In this example, the shift time total is L hours, which is the sum of nurse Betty's total time of J hours and nurse Craig's total time of K hours.

In the same way that the nursing diagnoses, interventions, and orders can be automatically identified from the medical findings, such as shown in FIG. 3, nursing schedules can also be automatically generated from the medical findings. In this way, nurse schedules can be generated in real-time, or shortly after the caregiver has entered medical findings. This enables, for example, the prediction of nurse staffing requirements. It also enables nurse staffing adjustments, such as to transfer nurses from a unit that is predicted to have less need, to another unit, area, or facility that has a greater need. Even if the system determines that there may be multiple possible orders that would be appropriate in view of the one or more medical findings for a patient, the system can still evaluate the set of possible orders to determine a range of nursing time requirements to complete the possible orders, and this information can then be used to evaluate scheduling needs.

FIG. 26 illustrates an example of a nurse staffing report 566 generated by the nurse scheduling engine 552, shown in FIG. 25. In some embodiments, the report 566 is a user interface displayed on a computing device. The report 566 displays, for example, information about the current workload of the nurses, units, and entire healthcare facility. The report is generated for a particular time period, such as a single shift, multiple shifts, a day, a week, a month, or other time periods. The example report 566 is generated for a single shift, and specifically Shift 1 of Day 1.

Report 566 includes a status region 568 for the entire healthcare facility. The status region includes the total number of nurses that are scheduled (display 570), the total shift time available (display 572), and the total scheduled shift time (display 574). For example, display 570 shows that there are 20 nurses scheduled to work in the healthcare facility during this shift, and display 572 shows that those nurses are available to work a combined total of 160 hours during that shift. Display 574 shows that the nurses are currently assigned to carry out procedures that are estimated to require 166 hours of time. The data displayed in displays 570, 572, and 574 is obtained from the data tables 554 and adding up data from the appropriate fields. This information can then be used to determine whether adjustments are needed or desired, and to suggest possible adjustments that can be made. For example, if additional nurse hours are needed, nurses can be asked to work overtime, or additional nurses can be added to the schedule.

In some embodiments, displays are color coded to identify the current state of the scheduled workload as compared to the nurse hours that are available. For example, display 574 is displayed with a first color (e.g., red), which indicates that the procedures that are currently scheduled significantly exceed the available time that nurses are available to work during the shift. The display 574 is displayed with a color to indicate the current workload of the healthcare facility. A second color (e.g., green) is used to indicate a workload that is within an acceptable range. A third color (e.g., yellow) is used to indicate a workload that is slightly over the acceptable range. A fourth color (e.g., blue) is used to indicate a workload that is significantly under the acceptable range. More, fewer, or different colors are used in other embodiments. In some embodiments, the color is a font color. In some embodiments, the color is a background color. In other embodiments, other graphical representations are used to identify the workload, such as different fonts, font types, font styles, graphical icons (e.g., exclamation mark, stop sign, caution sign, green light), or other distinguishable graphical representations.

Status region 576 displays the statuses of particular nurses that are scheduled to work during this shift. In this example, status region 576 shows that nurses Betty and Craig are scheduled to work, and that each nurse has 8 hours available to work during that shift. Displays 578 and 580 show the scheduled nurse time for each nurse, which is the sum of the estimated times for each procedure that the nurse has been assigned to perform, such as shown in FIG. 25.

In this example, nurse Betty will be working an 8 hour shift, but has been scheduled for procedures estimated to take 8.5 hours. As a result, display 578 is displayed with a third color (e.g., yellow) that indicates that nurse Betty is slightly over the available time.

Nurse Craig is also available to work 8 hours, but display 580 indicates that nurse Craig is currently scheduled to perform procedures totaling 9 hours. As a result, display 580 is displayed with a first color (e.g., red) indicating that nurse Craig has been scheduled for too many procedures, and is significantly over nurse Craig's available time for this shift.

Unit status region 582 displays the statuses of the various units of a healthcare facility. In this example status region shows the status of Unit 1 and Unit 2. Unit 1 currently has nurses scheduled to work a combined total of 32 hours during this shift. Display 584 displays the scheduled nurse time, which is the sum of the time estimates for all procedures that the nurses in the unit have been scheduled to work. For example, the nurses in Unit 1 are currently scheduled to perform procedures having a combined estimated time of 33 hours. The 33 hours is slightly above the available time, and so display 584 is displayed in a third color (e.g., yellow). The nurses in Unit 2 are available to work 40 hours during this shift, and are currently scheduled to perform procedures having a combined estimated time of 35 hours, as shown in display 586. As a result, display 586 is shown in a fourth color (e.g., blue), to indicate that Unit 2 is currently projected to have a lower workload than the available time. This may indicate, for example, that one of the nurses in Unit 2 can provide support for another Unit that is expected to have a workload that is significantly over the available time.

In order to generate unit status region 582, some embodiments include a nurse unit table that associates each nurse with the unit that the nurse is scheduled to be working in during a given period of time. In this way, the nurse scheduling engine 552 can lookup which nurses are scheduled to be in the unit, and then compute the combined time totals.

The present disclosure describes some of the many possible embodiments by way of specific examples. There are many additional embodiments that are possible. For example, additional embodiments can be formed by substituting the examples specifically described herein with alternatives. For example, alternative hardware devices and configurations, alternative medical findings, alternative nursing diagnoses (or orders, protocols, etc.), alternative user interfaces, alternative user interface controls, alternative diagnoses, alternative processes, alternative algorithms, and other alternatives can be used to form yet further embodiments in addition to those specifically described herein.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system comprising:
a data store encoded on at least one memory device, the data store comprising:
medical terminology including medical terms;
nursing terminology including nursing terms;
relationship data defining hierarchical relationships between the nursing terms, and further defining relationships between at least some of the nursing terms and at least some of the medical terms; and
at least one medical record associated with a patient, the medical record including medical terms from the medical terminology that identify at least one medical finding for the patient; and
a computing device in data communication with the data store, wherein the computing device is programmed to retrieve the at least one medical finding from the medical record and to automatically identify at least one nursing term from the nursing terminology associated with the medical finding.

2. The system of claim 1, wherein the medical finding is a finding made by a physician, and wherein the finding is selected from a symptom, a history, a physical examination finding, a test, a diagnosis, and a therapy.

3. The system of claim 1, wherein the computing device is further programmed to generate user interface data defining a user interface, the user interface data defining a physician window and a nursing window, wherein the physician window includes medical terms and the nursing window includes nursing terms.

4. The system of claim 3, wherein the physician window and the nursing window are synchronized, such that at least one of the medical terms in the physician window is associated with at least one of the nursing terms in the nursing window.

5. The system of claim 1, wherein the nursing terms include diagnoses, interventions, and orders, and wherein the relationship data links each diagnosis to at least one intervention, and links each intervention to at least one order.

6. The system of claim 5, wherein each nursing order includes a list of at least one nursing order protocol to be performed by a nurse to complete the order.

7. The system of claim 6, wherein the data store includes a first standard nursing order protocol and a different second custom nursing order protocol, and wherein the computing device is programmed to automatically utilize the second custom nursing order protocol instead of the first nursing order.

8. The system of claim 6, wherein each nursing order is associated with an average duration of time that is required by a nurse to complete the nursing order.

9. The system of claim 1, wherein the computing device includes a report generation engine, the report generation engine programmed to generate a report from data in the data store, the report providing information about nursing care provided to at least one patient.

10. A method of generating a user interface for use in providing nursing care to a patient, the method comprising:
automatically identifying, with a computing device, a category of nursing care based on at least one element of a patient's medical record; and
generating a user interface including a nursing order associated with the category of nursing care, the nursing order defining at least one nursing order protocol to be performed by at least one nurse to care for a patient.

11. The method of claim 10, wherein the element of a patient's medical record is a medical finding from a patient note, the medical finding selected from the group consisting of a symptom, a history, a physical examination finding, a test, a therapy, and a diagnosis.

12. The method of claim 11, wherein the category of nursing care is a nursing diagnosis, and wherein automatically identifying a category of nursing care comprises:
searching a plurality of nursing diagnoses tables to identify at least one nursing diagnosis table including the at least one element; and
identifying the nursing diagnosis associated with the at least one nursing diagnosis table.

13. The method of claim 12, further comprising:
determining a nursing intervention associated with the nursing diagnosis by looking up the nursing intervention from the nursing diagnosis table;
determining the nursing order associated with the nursing diagnosis by looking up the nursing order from a nursing intervention table associated with the nursing intervention.

14. The method of claim 13, further comprising:
including the nursing diagnosis, the nursing intervention, and the nursing order in the user interface, wherein the nursing order identifies at least one nursing order protocol to be performed to achieve the nursing intervention.

15. The method of claim 10, wherein the nursing order is associated with an average duration of time required to complete the nursing order.

16. The method of claim 10, further comprising:
storing data in a nursing record in response to inputs provided by a nurse through the user interface, the data defining actions that have been taken by the nurse to care for the patient.

17. The method of claim 16, further comprising receiving an input through the user interface and, in response, generating a report based at least in part on data in the nursing record to summarize nursing care provided to the patient over a period of time.

18. The method of claim 16, further comprising receiving an input through the user interface, and, in response, compiling data from the nursing records of multiple patients and generating a report based on the compiled data to summarize nursing care provided to the multiple patients over a period of time.

19. The method of claim 10, wherein generating a user interface including the nursing order comprises:
determining whether a custom nursing order protocol has been defined for the nursing order that overrides a standard nursing order protocol for the nursing order; and
inserting the custom nursing order protocol into the user interface if the custom order protocol has been defined for the nursing order; and
inserting the standard nursing order protocol into the user interface if the custom order protocol has not been defined for the nursing order.

20. A method of displaying health information associated with a patient, the method comprising:
generating data defining a user interface with a computing device, the user interface including a physician window and a nursing window, the physician window configured to display medical data associated with a patient, and the nursing window configured to display nursing data associated with the patient, wherein the physician window and the nursing window are synchronized such that the medical data displayed in the physician window is associated with the nursing data displayed in the nursing window.

21. A system comprising:
a data store encoded on at least one memory device, the data store comprising nurse schedule data, wherein the nurse schedule data identifies procedures to be performed by nurses and an estimated time required to perform each procedure; and
a computing device in data communication with the data store, wherein the computing device is programmed to retrieve the nurse scheduling data and to generate a report displaying a workload for one or more nurses utilizing the nurse scheduling data.

22. A method of evaluating a nurse staffing level, the method comprising:
determining a set of procedures to be performed by one or more nurses over a period of time;
computing, with a computing device, a scheduled nurse time, wherein the scheduled nurse time is an estimated duration of time required to complete the set of procedures;
computing an available nurse time, wherein the available nurse time is a combined duration of time that the one or more nurses are expected to work over the period of time; and
comparing the scheduled nurse time to the available nurse time.

23. The method of claim 22, wherein the set of procedures is a set of nursing orders.

24. The method of claim 22, further comprising automatically determining at least one of the procedures upon entry of one or more medical findings by a physician.
